(19) United States
(12) Patent Application Publication
(10) Pub. No.: US 2026/0355972 A1
(43) Pub. Date: Nov. 12, 2026

(54) Mobile Infrastructure System

(71) Applicant: Next-Gen Engineering and Research Development LLC, Ellicott City, MD (US)

(72) Inventors: Steven Tyler MOORE, Ellicott City, MD (US); Brock Thomas PELLERIN, Huntington Beach, CA (US)

(73) Assignee: Next-Gen Engineering and Research Development LLC, Ellicott City, MD (US)

(21) Appl. No.: 19/654,948

(22) Filed: Apr. 22, 2026

Related U.S. Application Data
(60) Provisional application No. 63/800,548, filed on May 6, 2025.

(51) Int. Cl. B25J 11/00; B25J 5/02; B25J 9/00; B25J 9/02; B25J 9/16; B25J 13/00; B25J 19/00

(52) U.S. Cl. CPC B25J 11/008; B25J 5/02; B25J 9/0009; B25J 9/0096; B25J 9/026; B25J 9/1664; B25J 9/1679; B25J 9/1697; B25J 13/006; B25J 19/005

(57) ABSTRACT

A mobile infrastructure system and method for operating the same includes a plurality of mobile devices, a plurality of remote systems having a diagnostic controller and a transportable platform in communication with the plurality of remote systems with a hybrid cable comprising an optical fiber and an electrical conductor. The transportable platform includes a fault-managed power generation system coupled to the transportable platform, and a robotic cable management system coupled to the transportable platform, the cable management system has a vision-guided reel handler retrieving a plurality of cable reels each comprising the hybrid cable. A cable diagnostic system receives data from the diagnostic controller; and a controller forms a cellular wireless network with the plurality of mobile devices, operating the cable diagnostic system and controlling distribution of power through the hybrid cable.

### CROSS-REFERENCE TO RELATED APPLICATION

The present application claims priority to provisional patent application Serial No. 63/800,548, filed on May 6, 2025, which is incorporated by reference herein.

### FIELD

The present disclosure relates to a mobile infrastructure system for powering and providing connectivity to a geographic area with such services.

### BACKGROUND

This section provides background information related to the present disclosure which is not necessarily prior art.

Establishing reliable power and data connectivity in remote, temporary, or underdeveloped locations presents significant challenges. Industries such as oil and gas, mining, construction, disaster relief, and military operations frequently require robust infrastructure in areas far from established grids and communication networks.

Delivery of power in in remote in such circumstances can be challenging. Conventional mobile power solutions, typically diesel generators, face limitations in efficiently distributing power over large areas. Extending low-voltage AC or DC power requires heavy, expensive cabling with significant voltage drop over distance, limiting practical reach. Safety concerns also arise with high-power, long-distance distribution in temporary field environments. While technologies like Class 2 power circuits exist, they are often limited in the wattage they can deliver over distance. There is a need for a mobile system that can safely and efficiently deliver substantial power (kilowatts) to multiple points across distances of kilometers.

Data connectivity is also challenging in extreme circumstances. Similarly, providing reliable, high-bandwidth data connectivity across expansive field sites is difficult. Deploying fiber optic cables temporarily is labor-intensive and the cables are susceptible to damage. Wireless solutions like Wi-Fi have limited range, while traditional cellular coverage may be weak or non-existent in remote areas. Satellite backhaul offers broad coverage but often suffers from high latency and limited bandwidth, unsuitable for real-time control or high-throughput applications. Mobile cellular base stations (Cells-on-Wheels or COWs) exist, but often rely on a single, vulnerable backhaul link (satellite or microwave) and lack integrated, long-reach power distribution for associated equipment. Mesh networks offer resilience but integrating them effectively with both private cellular access and reliable, multi-path backhaul with seamless public network failover presents integration challenges.

Diagnostics in extreme conditions also presents challenges. Maintaining the integrity and functionality of infrastructure in the field, particularly existing assets, is problematic. Faults in power or data cables deployed in harsh field conditions are common. Locating these faults often involves manual, time-consuming, and potentially hazardous troubleshooting using handheld time domain reflectometers (TDR) or other specialized test equipment after a system failure, leading to extended downtime. Existing automated monitoring is often limited or non-existent for legacy systems, and conventional TDR techniques applied manually struggle with complexities or detecting subtle degradation, especially in branched networks or with soft faults (e.g., partial insulation damage). Moreover, diagnosing failures in existing field equipment (like remote radios damaged by lightning, network switches affected by power surges, or malfunctioning PLCs in SCADA boxes) typically requires dispatching technicians with specialized, often bulky, test gear, incurring significant delays and costs. There is no conventional mobile system that integrates comprehensive, deployable diagnostic capabilities designed to interface with and test surrounding field assets remotely and proactively.

Therefore, a significant unmet need exists for an integrated, mobile system that overcomes these limitations by providing self-sufficient power generation/storage (with flexible source options), safe and efficient long-distance power distribution (e.g., Class 4), a hybrid approach to high-bandwidth and resilient data networking (offering both wired fiber and wireless mesh options via configurable endpoints, robust backhaul with public failover), onboard compute capabilities, automated, proactive, and comprehensive diagnostics deployable to test connected or nearby existing field equipment and infrastructure (including advanced TDR techniques), and efficient, operator-assisted deployment mechanisms (like vision-guided handling), all within a single, rapidly deployable platform.

### SUMMARY

This section provides a general summary of the disclosure, and is not a comprehensive disclosure of its full scope or all of its features.

The present invention provides a novel, integrated mobile infrastructure system designed to overcome the limitations set forth above. In general, the system is a mobile, self-sufficient, modular, configurable, and redundant platform that delivers comprehensive power, data networking, edge compute, and diagnostic infrastructure over wide areas. This system is realized through the synergistic combination of several different core technological advancements, each of which possesses individual novelty, their integration yields capabilities significantly beyond the sum of their parts.

This integrated system functions as a deployable "infrastructure-in-a-box." Housed on a rugged trailer or skid, it contains its own configurable power generation (supporting traditional gensets, solar, hydrogen) and substantial battery storage, allowing for extended autonomous operation. Its primary function is to establish a localized microgrid and communications network rapidly upon arrival at a site. This is achieved by deploying specialized hybrid cables, carrying both fault-managed, high-voltage Class 4 DC power and high-bandwidth optical fiber, using a gantry-based pick-and-place mechanism to transfer the cable end onto an external vehicle (e.g., ATV, truck, snowmobile) which then lays the cable passively by driving away. Retrieval involves motorized respooling onto reels which are then handled and restocked onto the trailer by the pick-and-place mechanism. This unique combination of safe, long-distance power delivery, reliable data connectivity, and efficient cable handling forms the foundation of the system's operational advantage.

Building upon this foundation, the system incorporates sophisticated wireless networking, including high-capacity backhaul links and local private cellular (5G/LTE) or Wi-Fi coverage, potentially forming a self-healing mesh with other similar units for enhanced resilience and coverage. Advanced SIM management allows seamless transitions between private and public networks. Furthermore, the platform includes a modular compute core capable of hosting servers, AI accelerators, data storage, and advanced networking equipment. Comprehensive diagnostics monitor the system's own health (including TDR for cable integrity) and leverage highly configurable remote endpoints as test heads to diagnose existing external field equipment. The system's modularity extends from the internal compute core to the remote endpoints, allowing tailoring of power outputs, data interfaces, and diagnostic tools to specific mission needs.

The system includes a mobile hybrid power and data system is set forth. This system forms the physical backbone and core power/data distribution capability which is mounted on a trailer or skid. The power and data system includes configurable onboard power such as substantial battery storage (e.g., 50-500 kWh capacity) coupled with flexible power generation options configured based on deployment needs, including traditional diesel/propane gensets, integrated solar panel arrays, or hydrogen fuel cell systems, all managed for optimal efficiency.

Class 4 power distribution utilizes fault-managed power technology (e.g., VoltServer Digital Electricity™) to transmit high-voltage DC (~336V) safely over long distances.

The system also includes a hybrid cable deployment and retrieval system that employs a pick-and-place mechanism (e.g., gantry-based) to handle the cable end for deployment via external vehicle, and a motorized respooling system for retrieval, with the pick-and-place mechanism restocking the full reels. The system enables deployment and retrieval over distances up to 2 km. The cables feature connectors reinforced with amorphous metal alloy structures for enhanced durability during deployment and retrieval.

An integrated communications hub and compute core is also included in the system The hub and compute core Includes high-capacity wireless backhaul capabilities, potentially utilizing aggregated public cellular links (e.g., via multi-modem hardware like SailaWave) or dedicated point-to-point radios (e.g., mmWave), with the cellular aggregation approach specifically enabling resilient mesh networking between multiple mobile platforms. The system incorporates standard private 5G/LTE node functionality for local wireless access. Contains a modular compute core housed in standard server racks capable of hosting servers, AI accelerators, data storage, and advanced network switches. Highly modular and configurable remote endpoint connects the hybrid cable to remote endpoint enclosures. These enclosures are designed for modularity, housing power conversion circuitry to provide a wide array of output voltages (AC/DC, High/Low Voltage) and integrating diverse, configurable connectivity and diagnostic options (wired and wireless interfaces, TDR nodes, RF test equipment, network analyzers, etc.) along with specific payloads (sensors, cameras) tailored to the application.

A distributed private wireless mesh network is also provided. The subsystem delivers highly resilient, adaptable, and wide-area wireless data connectivity, addressing the limitations of traditional fixed or single-node mobile wireless deployments. It is designed to operate potentially using multiple mobile platforms as interconnected nodes, creating a robust network fabric ideal for demanding field operations where infrastructure is unreliable or non-existent. Key characteristics include a private cellular foundation where each mobile node establishes a local coverage bubble using standard private 5G or LTE technology (e.g., Comba RAN paired with an edge core like Monogoto running on the onboard compute). This provides high-performance, secure wireless access for authorized user devices (tablets, phones) and IoT sensors within the node's vicinity.

The system also includes a self-healing mesh backhaul. Unlike traditional cellular-on-wheels (COWs) relying on single point-to-point backhaul links, this system employs advanced multi-directional wireless backhaul technology (e.g., SailaWave multi-modem/multi-antenna systems using aggregated public cellular or dedicated frequencies). This allows each mobile node to establish simultaneous, high-throughput links with multiple neighboring nodes or available public networks. These links form a dynamic mesh topology where data traffic can be automatically rerouted through alternative paths if any single link or node fails, ensuring high availability.

The system integrates sophisticated SIM management capabilities (e.g., using Monogoto's platform with multi-APN/IMSI support) to allow authorized devices to automatically and seamlessly roam between the secure private network when in range, and public cellular carrier networks when outside private coverage or if the private network experiences an outage. This ensures continuous connectivity for critical mobile assets and personnel across a wider operational area.

The network's behavior, including roaming policies, backhaul link selection, traffic prioritization, and failover responses, is managed through software and API orchestration (e.g., Monogoto's API). This enables programmatic control and automation, allowing the network to dynamically adapt to changing conditions or operational needs, enhancing resilience and simplifying management. This approach addresses critical needs identified in industries like mining and oil & gas for truly reliable and adaptable field communications.

Distributed Time Domain Reflectometry (TDR) Cable Fault Detection is also provided for advanced, continuous monitoring and diagnostics for the critical deployed hybrid cable infrastructure, overcoming the significant limitations of traditional cable testing methods. Conventional single-ended time domain reflectometry struggles with accurately locating faults in complex, branched networks often found in field deployments, and is often unable to detect subtle degradation ("soft faults") before they cause complete failure. This disclosure employs a distributed architecture to address these shortcomings.

Multiple smart TDR edge devices (e.g., based on Arduino Portenta C33 microcontrollers with custom analog front-ends) are deployed at various points along the hybrid cable network, potentially integrated within the modular remote endpoints. Each device is remotely powered via the integrated Class 4 Digital Electricity system, eliminating the need for local batteries or power source. These nodes periodically inject TDR pulses into their respective cable segments and capture the reflection waveforms. Crucially, each measurement is precisely timestamped and geotagged using onboard GPS receivers, enabling accurate correlation of data from across the network. This data is transmitted via the hybrid cable's fiber back to a central server, likely hosted within the mobile platform's compute core. This central server utilizes advanced algorithms and potentially AI/ML to fuse the synchronized, geotagged data from multiple nodes, allowing for accurate fault triangulation even in complex branched topologies, enhanced classification of fault types (opens, shorts, water ingress, partial degradation) based on waveform analysis, and predictive analytics to identify incipient issues before they lead to failure. This distributed, remotely powered, GPS-synchronized, and AI-enhanced approach represents a significant improvement over manual or single-point TDR testing, providing unparalleled real-time visibility into cable health across the entire deployed infrastructure.

Integrated system operation and diagnostics is also provided. Synergy arises from combining the elements various elements. The mobile platform provides the physical deployment mechanism, power source, onboard computer, and basic connectivity via highly versatile remote endpoints. The wireless mesh ensures resilient data backhaul and wide-area coverage, potentially linking multiple mobile platforms. The TDR system monitors the critical hybrid cable infrastructure. Crucially, the comprehensive diagnostic capability extends beyond TDR; the modular endpoints, leveraging their integrated power and multi-modal connectivity (wired fiber, local wireless), can be equipped as remote test heads to diagnose failures in existing external field equipment (radios, switches, PLCs). All diagnostic data is relayed back (via fiber or mesh) to the central compute core for analysis, visualization, and alerting, enabling proactive maintenance and rapid troubleshooting of the entire operational environment.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1A is a block diagrammatic view of a mesh network with a plurality of mobile platform systems.

FIG. 1B is a rear-side perspective view of a mobile platform system.

FIG. 1C is a front-side perspective view of a mobile platform system.

FIG. 1D-1 and 1D-2 are a continued block diagrammatic view of a mobile platform systems.

FIG. 1E is a block diagrammatic view of a remote system or endpoint.

FIG. 2A is a perspective view of the robotic cable handling and deployment system.

FIG. 2B is a side view of the robotic cable handling and deployment system.

FIG. 2C-1 and 2C-2 are a continued block diagram of the cable management system.

FIG. 3A is a high level block diagrammatic view of two cells and mobile platform systems forming a portion of a mesh network.

FIG. 3B is a flowchart of a method for operating a mesh system.

FIG. 4 is a block diagrammatic view of a fault detection system. of

Corresponding reference numerals indicate corresponding parts throughout the several views of the drawings.

### DETAILED DESCRIPTION

Example embodiments will now be described more fully with reference to the accompanying drawings.

A mobile infrastructure system and methods includes various aspects provided on a mobile platform. The different aspects are described briefly here and are set forth in greater detail below.

A mobile power distribution subsystem incorporates data connectivity. In the field, a platform such as a trailer carries reels of hybrid fiber-optic power cable that can be laid out to deliver power and network connectivity to distant equipment. The power subsystem provides a Class 4 fault-managed power distribution (often referred to as “Digital Electricity”) delivered over a hybrid cable that contains both copper conductors and optical fibers. This enables the system to safely send high-voltage DC power (hundreds of watts to kWs) over long distances (about 1–2 km) while simultaneously providing a fiber data link to remote endpoints. Notably, the platform includes a reel deployment that automates the handling and payout of these heavy hybrid cables across rough terrain. The combination of long-reach power, high-bandwidth data, and automated deployment in a mobile unit is at the core of this subsystem’s innovation.

The mobile power and data distribution subsystem has several features a Class 4 fault-managed power system on a mobile platform. The use of a Class 4 power distribution system (a fault-managed high-voltage DC power system) in a transportable unit to send significant power over kilometer-scale distances is novel. Class 4 power is defined in the National Electrical Code (NEC 2023) and allows sending high voltage/current with intelligent fault monitoring, unlike traditional low-voltage mobile power which is limited in range. Previous mobile generators or battery trailers provide power, but none deliver power safely for distances of about 1–2 km. This subsystem effectively brings utility-scale remote powering capability (previously seen only in fixed installations) into the field in a mobile form.

The mobile power and data distribution subsystem includes hybrid fiber-optic power cable integration. That is, the subsystem employs a single hybrid cable that contains both power conductors and optical fibers, enabling simultaneous power transmission and data communication to remote equipment. While hybrid cables are known in fixed telecom installations (e.g. powering remote radio units on cell towers), in a mobile context this has not been seen. Conventional mobile units may not provide data. However, when they do, separate data cables or wireless links are used. Here, the integration of fiber in the power cable provides a robust, high-bandwidth data link alongside power a unique combination for deployable systems.

The mobile infrastructure system also includes automated a pick-and-place cable deployment mechanism. The platform is equipped with a robotic cable reel handling system that can pick up, deploy, and retrieve cable reels, including transferring a reel onto an off-road vehicle for extended pay-out. This goes beyond standard cable spool mechanisms. It uses a machine-vision-assisted gripper to align and latch onto the heavy reel, enabling one system to quickly lay out cable over difficult terrain with minimal manual labor. Such a self-contained, automated deployment of long power/data lines is not found in prior mobile power solutions which typically require manual deployment or simple winch systems without intelligent alignment.

The mobile infrastructure system also employs ruggedized high-durability connectors and endpoints: The system uses reinforced connectors, for example employing amorphous metal (“liquid metal”) alloys for strain relief and strength. This provides durability for repeated deployments in harsh conditions. Additionally, modular remote endpoint units (sometimes called “briefcase” enclosures) are attached at the end of the hybrid cable to convert the Class 4 power to usable form and provide data interfaces. The endpoints can host various equipment (e.g. radios, sensors, or test devices) and are designed for field use (rugged, weatherproof). The mobile system may be used to place remote nodes kilometers away that are fully powered and network-connected by a single cable, essentially creating instant infrastructure in the field.

The present system provides improves known systems. Conventional mobile generator trailers supply power but over short distances (tens of meters) and without integrated data, often leaving communications as a separate problem. Conversely, fixed installations of fault-managed power systems (like VoltServer’s Digital Electricity) exist in buildings or campuses, but those are not mobile and typically not paired with autonomous cable deployment. The present subsystem’s ability to cover kilometer distances with a unified power-data link and automated handling is a new capability.

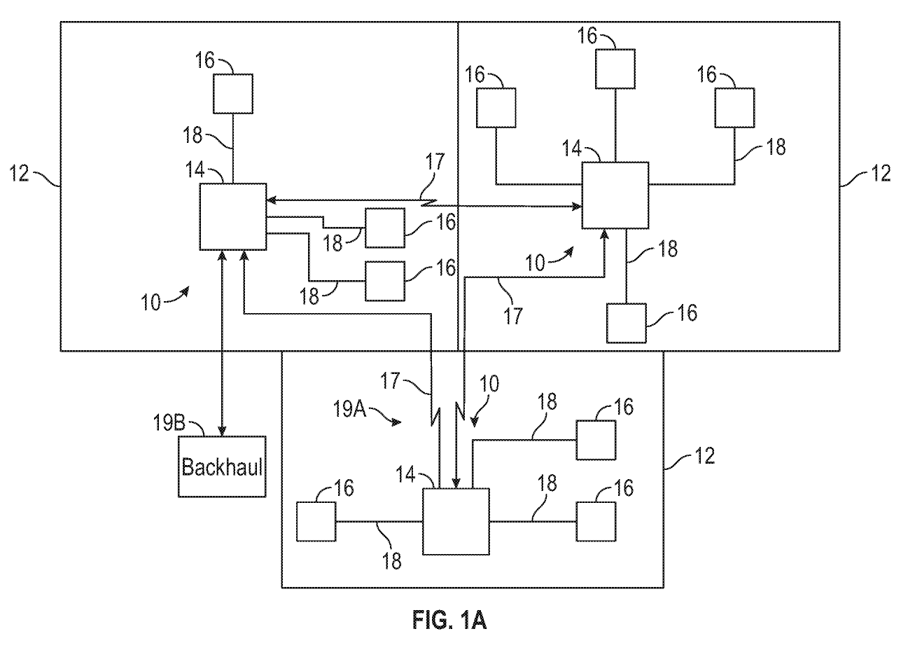

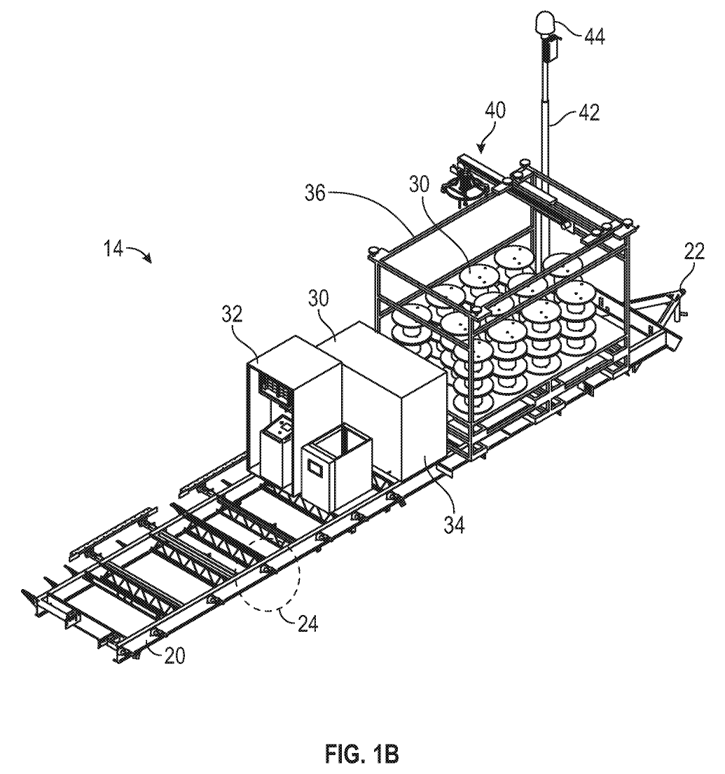

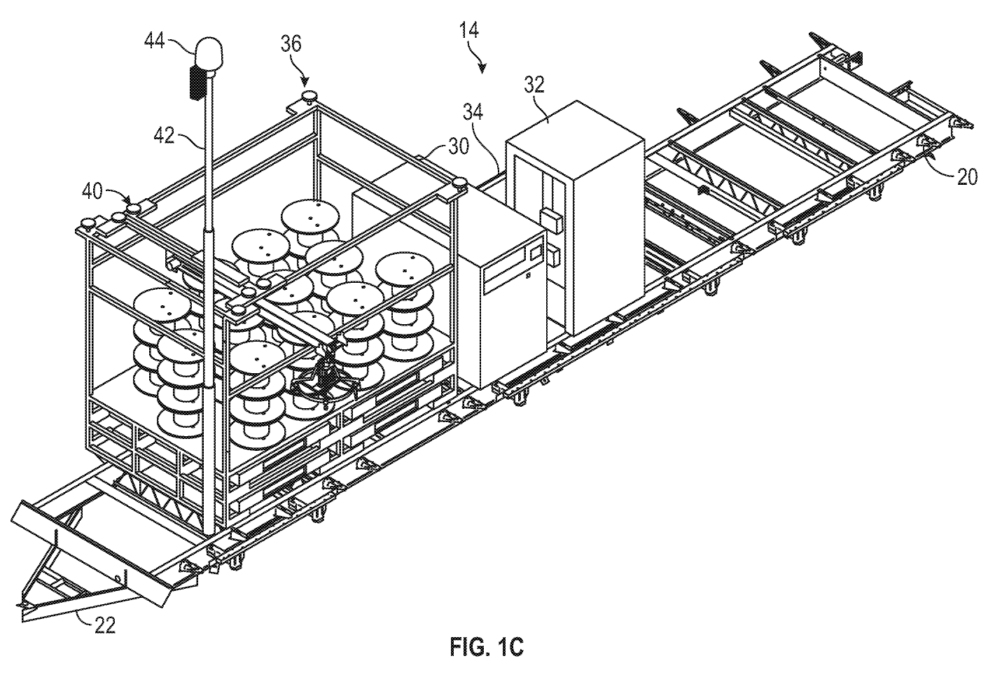

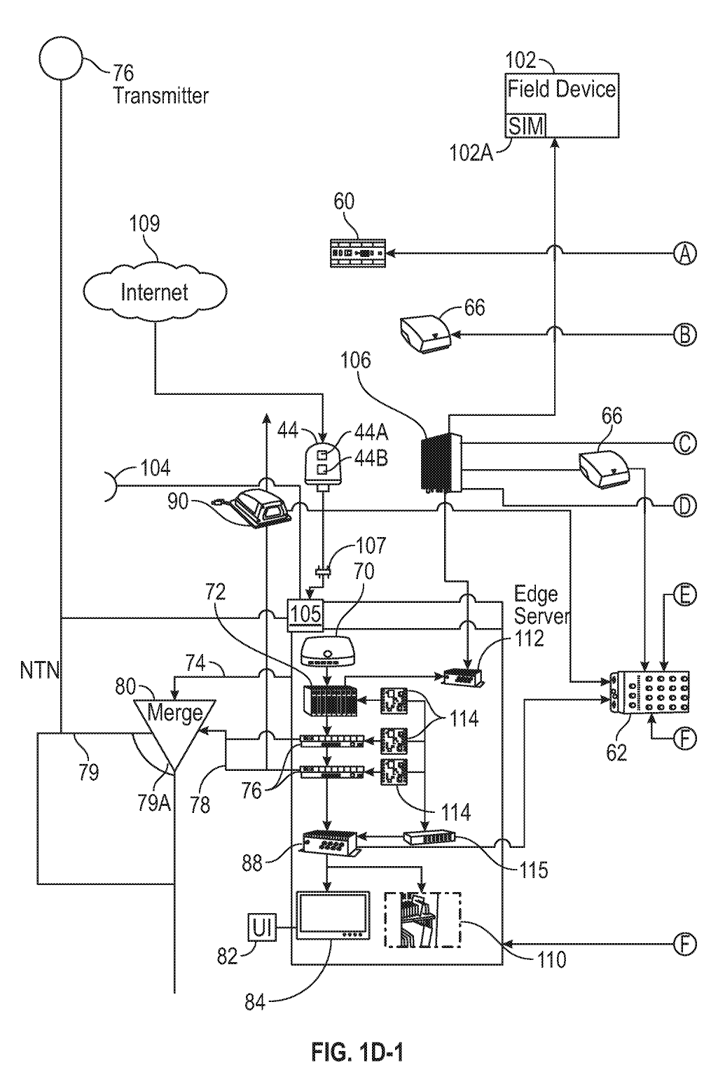

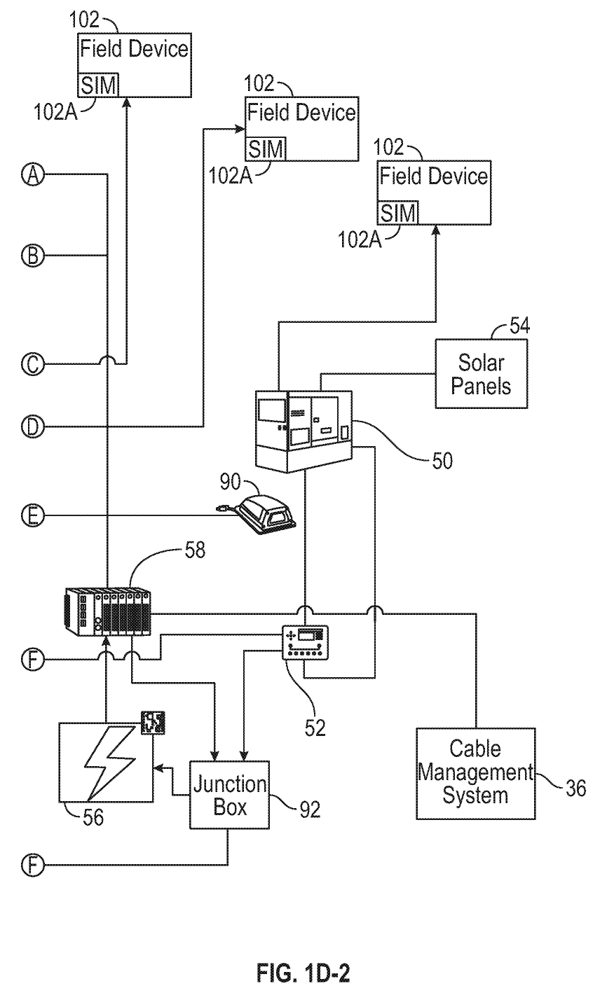

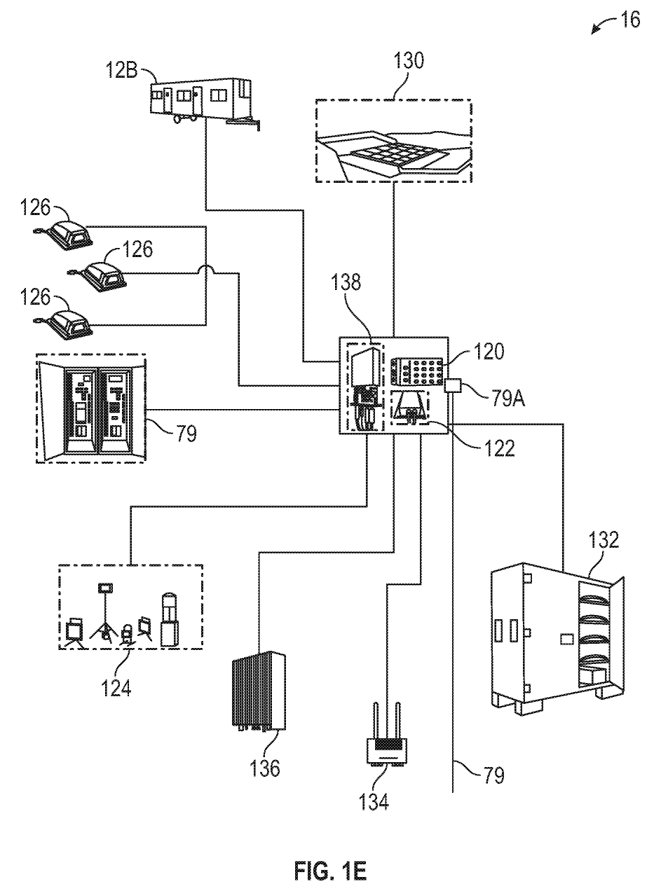

Referring now to FIG. 1A, a plurality of mobile infrastructure systems 10 are illustrated relative a plurality of geographic areas 12. The mobile infrastructure systems 10 include a mobile or platform system 14 that is in communication with a plurality of remote systems 16. Each of the mobile platforms 14 are in communication with a plurality of remote systems 16 through a plurality of cables 18. As will be described in greater detail below, the cables 18 may include optical fibers and electrical conductors for communicating data and power to the remote systems 16. Each mobile infrastructure system 10 may be an independent stand-alone system. However, the mobile infrastructure systems 10 may also intercommunicate using the signals through links 17 to form a mesh network 19A with the backhaul 19 as will be described in greater detail below. The backhaul may be cellular, satellite, microwave, 60Hz, optical fiber, WAN or combinations thereof.

The mobile infrastructure systems 10 may be used in various industries including but not limited to oil and gas, mining, disaster relief, construction sites, military and tactical deployments, agriculture and small cities or large temporary events.

Referring now to FIGS. 1B and 1C, the mobile system 14 is illustrated in greater detail. In the present example, the mobile platform system 14 includes a transportable platform 20. The platform 20 in this example is a trailer that has a tongue 22 so it may be pulled by tow vehicle. The platform 20 has wheels 24, one of which is illustrated. However, two or more wheels 24 may be incorporated onto the platform 20. The platform 20 may also be a structure that is transportable by way of an aircraft such as a helicopter or the like. The platform 20 may be formed of structural steel and cross-members to support the weight of the various components.

The mobile platform 14 includes a fault manage power generation system 30. The power generation system 30 may include a power generation housing 30, a control housing 32 and a server rack 34. The power generation housing 30, the control housing 32 and the server rack 34 may all be coupled to the platform 20. The control housing 32 and the server rack 34 include user interfaces and controller technologies for performing various functions as will be described in detail below.

A cable management system 36 is also coupled to the platform 20. The cable management handling system 36 is used for positioning and handling the cables and cable reels relative to the platform 20. A gantry system 40 under control of the cable management system 36 is used for moving the cable reels 38 as will be described in greater detail below. The cable management system 36 includes all the motors, the load cells, the control circuit boards and the like and the like for maneuvering the reels of cable.

A telescoping mast 42 is also coupled to the platform 20. The mast 42 is used for forming a private cellular network through a radio unit (RU) 44. The RU 44 may have two modems, a first modem 44A and a second modem 44B, that, as described later may be used to form a mesh with the nearest neighbor of the system 14 through the link 17 as well as forming a private cellular wireless network. The sims within the modems may allow connection to at least two different networks.

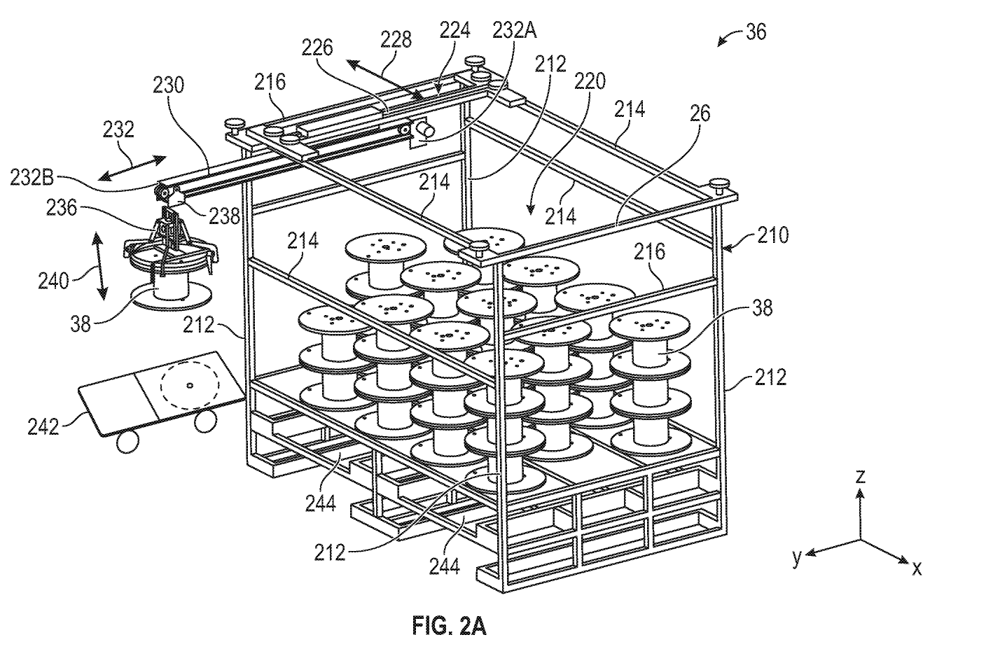

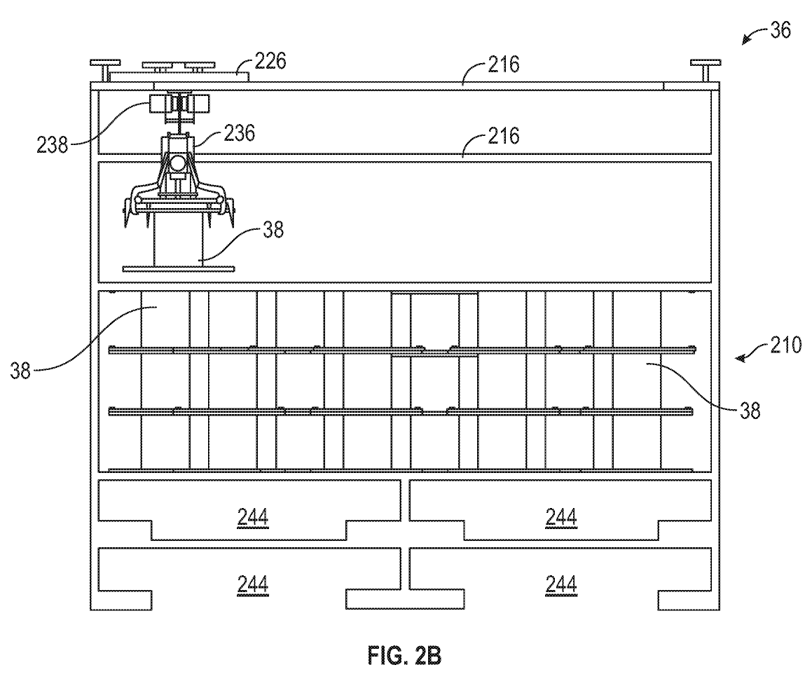

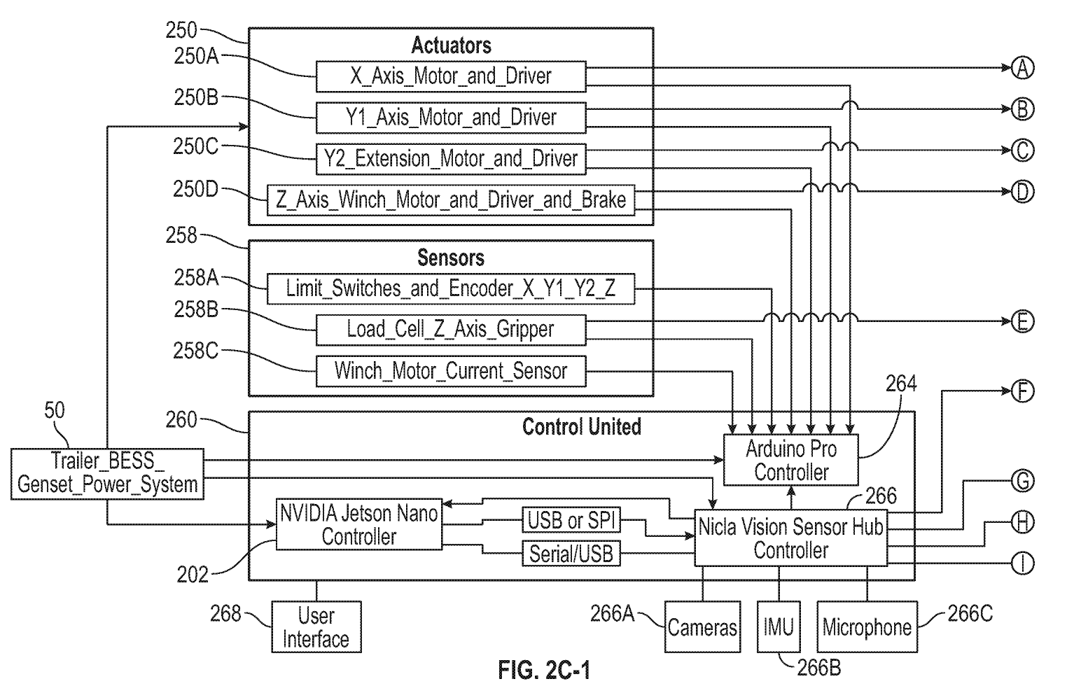

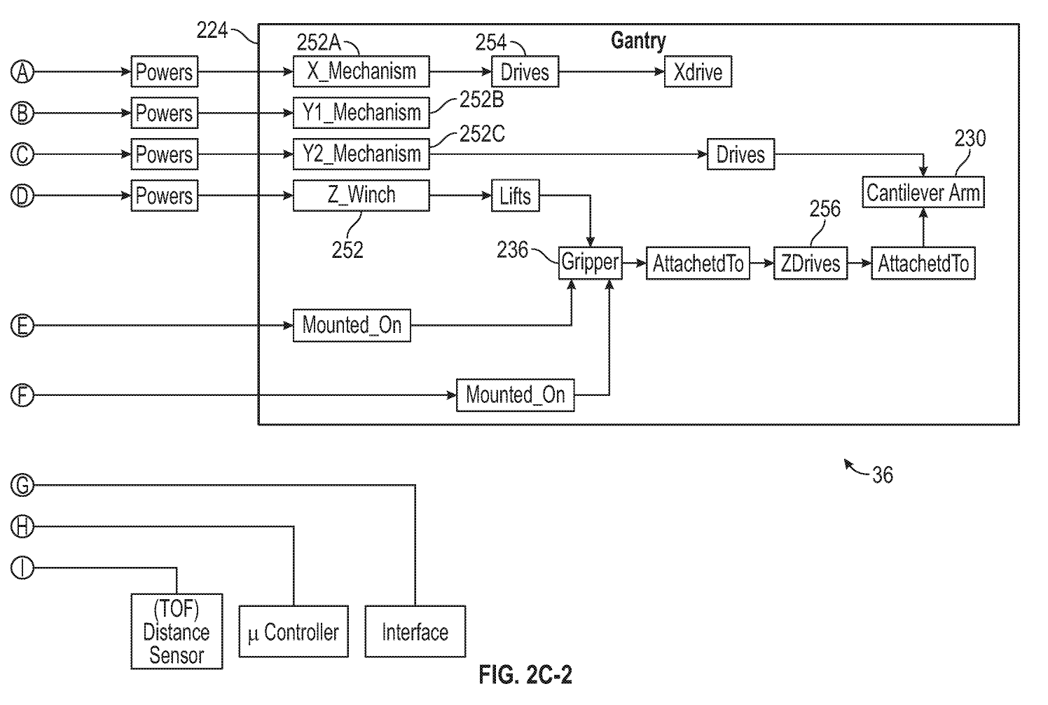

Referring now also to FIGS. 1D-1 and 1D-2, a high level schematic view of the mobile platform system 14 is set forth. In this example, a power generation system 50 is illustrated coupled to a power controller 52 that controls the power and charging of the power generation system 50. The power generation system 50 may be a diesel generator, a hydrogen generator or fuel cell or may be used in combination with solar panels 54. Batteries 56 may be used to store excess power and provide power needed during an event. A battery management system controller 58 may be used to control the state of charge within battery relative to the power generation system 50. The controller 58 may also be in communication with a mast controller 60 for raising and lowering the antenna mast, which may be controlling an electric motor and providing the operating. A controller 62 may be used to communicate with the heating ventilation and control (HVAC) units 64, 66. A server rack 68 is shown in communication with various components including a router 70, an optical transceiver 72 for transmitting and receiving signals through the optical fiber 74. Power transmitters 76 communicate power through electrical conductors 78. A merging device 80 is used to merge the optical signals and the power signals into a common cable for distribution as mentioned above. The system 10 may be controlled by a user interface 82 that is in communication with a display 84. An interface component 86 communicates with a device 62 to allow control thereof from the user interface 82. A system controller 88 is also provided. The system controller allows the user through the user interface 82 to communicate in control various components of the equipment.

For security purposes, cameras 90 may be included within the system. As described below, other cameras for positioning the components of the cable and handling system 36 may also be incorporated into the system as described below.

A junction box 92 may also be provided in the system. The junction box 92 allows power to be provided to the various systems such as the components within the server rack 68. A cable management system 36 is used for managing the cables and controlling the movement of the gripper and cable reels within the cable management system 36.

A plurality of mobile devices 102 (field devices) are in communication with the radio unit (RU) 44 and the antennas controlled therein using a SIM card 102A (SIM). The radio unit 44 may form a stand-alone private 5G network through a wireless cellular controller 106 such as a 5G network controller. However, other mobile platform systems 14 may intercommunicate as a mesh network as described below. Wi-Fi may also be generated from an antenna within the radio unit 44. The radio unit 44 allows interconnections through the wireless controller 106 and may allow Bluetooth connections as well. Interconnection to the Internet 109 may be provided as well.

The system may also include a satellite communication system 104 having a non-terrestrial network (NTN) modem 105 for providing the backhaul 19. The satellite communication system may be a primary backhaul or secondary, which is used as a backup to the primary means off backhaul communication. An ethernet connection 107 is set forth as well.

A tablet charging station 110 may also be provided. The tablet charging station 110 is used for charging tablet computers or other types of computers for use in and around the mobile platform 14.

The system 14 may also provide an edge server 112 used for coupling to the 5G controller and receiving signals therefrom. Environment and motion monitoring controllers 114 may be used to monitor various conditions. A USB hub 115 may also be included. The power transmitter 76 continuously monitors line conditions to instantly detect hazards shorts or human contact and shutoff if necessary.

Referring now to FIG. 1E, the remote systems 16 are illustrated in further detail. The remote systems 16 receive power at an interface block 120. The interface block 120 may be in communication with a power receiver 122 that receives the DC power from the conductors 78 and converts the power into a usable form at the remote site. The type of power, such as AC or DC and the voltage thereof, may change based on various conditions and the type of power used.

Various equipment 124, such as lights, pumping equipment and the like, may be controlled with the power from the power receiver 122. Also, security cameras 126 may be powered by the same power. The system may also be associated with a remote trailer 128 and power provided for the needs therein. A drone pore 130 may also be powered by the power from the power receiver 122. A charging cabinet 132 may also provide charging for various rechargeable equipment at the remote site. A router 134 may also be coupled within the system to form a local area network around the remote site.

A wireless system controller 136 such as a 5G controller may also be coupled to the power from power receiver 122 to form a cell for coverage to mobile devices therearound. A time-domain reflectometer (TDR) 138 may also be included for power and cable testing as described in greater detail below. All of the components may be placed within an endpoint cabinet 140 that is securely locked. The cabinet 140 may also be referred to as an end point.

“Class 4” power is a relatively newly defined category (in the 2023 National Electrical Code) for fault-managed power systems (FMPS). Class 4 allows high voltage electrical power to be sent (up to 450V) over ordinary cables without heavy conduit or insulation, because the system’s transmitter continuously monitors the line and will cut off power within milliseconds if a fault such as a short or shock hazard is detected. This limits the energy that can go into an accidental shock or arc, making it as safe as traditional low-voltage circuits even though the voltage is much higher. One benefit is power is not limited to ~100W like Class 2 (PoE) circuits. Hundreds or thousands of watts may be sent over a long distance on thin cables, as long as the system is managing any fault risk. In this system 10, a digital electricity (Class 4) transmitter 76 is mounted on the platform 20. The transmitter 76 sends out power in the form of rapid pulses (packets of energy). At the far end of the cable 78, the matching receiver 122 converts those pulses back into conventional DC power for the equipment to use. If the cable were cut or someone touched it, the transmitter 76 would detect the abnormal current draw and shut off almost instantly, preventing serious harm. In a field deployment, running a standard high-voltage line would be dangerous and likely prohibited without an electrician. Class 4 power lets the team safely reach devices a kilometer or more away with enough power to run radios, sensors, or other gear, which is something traditional mobile generators cannot do. Essentially, the platform 20 carries a portable power grid that intelligently manages itself.

The optical fiber 74 and the electrical conductors 78 are coupled together in a single cable 79. The cable 79 is used is a hybrid fiber-optic power cable, meaning inside a single jacket or sheathing the cable 79 has metal conductors 78 and one or more optical fibers 74. In the system 10, the conductors 78 carry the Class 4 power, and the fiber 74 carries data (network communications). The hybrid cable 79 is to simplify deployment as only one cable needs to be rolled out to a particular remote system and it provides both electricity and a high-speed data connection. The optical fiber 74 is immune to electromagnetic interference, so running it alongside a high-voltage DC line is without interference. The transmitter’s pulses are high-frequency, but any noise does not affect light signals in optical fiber 74. In practice, this means if a platform is placed 1 km away and drop a remote endpoint (remote system 16)that is allowed to be powered up and simultaneously connected as if by a gigabit Ethernet or fiber network link back to the trailer. Alternatives could have been a separate generator at the far end (which is logistically hard) or a wireless link for data (which might not have enough bandwidth or could be unreliable). The hybrid cable approach provides a reliable, wired backbone out to wherever needed.

Using a hybrid cable requires attention to connectors 79A and strength. The team incorporates amorphous metal strain-relief connectors and a have connector housings made of a metallic glass alloy often known by the trade name Liquidmetal®. This material is extremely strong and springy, which helps the connectors and cable ends survive being yanked, bent, or repeatedly connected/disconnected in the field. It prevents the cable from developing weak spots at the ends. Such durability is key when spooling out a heavy cable across rocks and then reel it back; normal connectors might crack or the fiber could break from strain. By using a custom rugged connector design, the system ensures the cable can be used multiple times in harsh conditions (industrial temperature swings, dust, rain, etc.).

Remote endpoints or systems 16 are used at the end of hybrid cable 79, which has a Class 4 receiver module that takes the incoming high-voltage pulsed power and converts it to, say, 48V DC (or whatever the local equipment need. The box also has networking hardware because the fiber from the mobile platform system 14 terminates there, typically one would have a media converter or network switch to provide local data ports (Ethernet, Wi-Fi AP, etc.). The remote systems 16 may be configured with different payloads. For example, one might carry a small 5G radio unit or a sensor package. In essence, the endpoint/remote system 16 is modular. The platform 20 plus hybrid cable 79 provides a pipeline of power and data, and the remote systems 16, the tool attach at the end to interface with whatever is wanted to operate or measure. This modularity supports various use cases (one time the surveillance camera 126 may be attached, another time a weather sensor, another time a TDR diagnostic device. By providing standard power and network at the endpoint, the system hugely extends its versatility.

Referring now to FIGS. 2A and 2B, the physical layout of the cable management system 36 is illustrated in further detail without the platform. A frame structure 210 is illustrated having vertical members 212 and longitudinal horizontal members 214. Lateral horizontal members 216 are also provided. A bay 220 is formed between the members 212, 214 and 216. The bay 220 stores reels 38 having hybrid optical/electrical conductor cables. A gantry 224 is movable supported by the longitudinal members 214 disposed at the top of the structure 210. The system has a main beam 226 that moves in the direction indicated by the arrows 228. A secondary or cantilevered arm 230 extends in the direction indicated by the arrow 232. That is, the cantilevered arm 230 moves in a lateral direction which in this case corresponds to the Y axis. The cantilevered arm 232 has a first end 232A that remains supported by the main beam 226 and a second beam 232B that supports a gripper 236. The gripper 236 is used for gripping a reel 38 that has cable wound thereon. The gripper 236 may rotate relative to a vertical axis and move in a direction indicated by the arrow 240. The gripper 236 may be used to unwind and feed cable to a system or person positioning the cable. The reel 38 may also be placed on a vehicle 242 wherein the vehicle is moved to position the cable in the desired position.

The structure 210 also includes battery openings 244 may receive the batteries 56 illustrated in FIG. 1D. The gripper 236 moves in a vertical direction in response to a winch motor 238. The motor may therefore adjust the position of the reel and the gripper 236.

The gripper 236 is a claw or clamp that can latch onto the center of a cable reel 38 (the spool). The reels 38 in question are large drum-like objects wound with the heavy hybrid cable. They have a central hub (like a spool or a big cylinder) that the gripper 236 can grab onto. The gripper 236 in this design might be passive, which implies it does not have complex fingers but maybe uses the weight of the reel or a spring to lock it in place once the reel is nestled into it. A common passive gripper for cylindrical objects is a pair of curved arms that pivot – when they push against the reel, they open, and once around the center, they spring shut. The advantage of passive is it is fail-safe and simple (fewer motors that could fail in the field). It likely relies on the motion axes to insert it correctly rather than actuating itself.

The gripping process may be automated because the cable 79 is thick and heavy. Kilometers of copper and fiber may weigh hundreds of kilograms. Manually deploying that is slow and dangerous (it could cause injury or get damaged).

Using the X and Y axes, the gantry 224 positions the gripper 236 above the reel 38. Then, the gripper 236 is lowered (Z axis) to engage the reel 38. The vision system at this stage, using a camera near the gripper 236, looks for a fiducial mark or just the shape of the reel’s hub to ensure it is centered. The sensors and camera will be described in more detail below. The gantry crane-like system 40 on the platform 20 can lift a full spool of cable, feed it out, and even place it on another vehicle. For example, an ATV or small vehicle 242 can carry the reel 38 off-road while the cable is unwinding. The rapid deployment dramatically speeds up laying cable across difficult terrain, since the small vehicle can zip along a path or pipe corridor pulling the cable, instead of humans carrying. The machine vision part uses a camera to help line up the robotic gripper with the reel’s center axis when picking it up which is useful because in bumpy outdoor conditions, the reel or vehicle might not be perfectly positioned, and a human operator cannot easily make fine adjustments by eye from the control panel. The vision system/camera detects the reel’s hub and guides the gripper to latch precisely. The system allows the simplified goal of rapid, one-stop deployment of driving the trailer out, press a button (or follow a guided procedure), and within an hour have a power/data line stretched a mile long powering devices, which is a huge improvement over the usual multi-day setup of generators, stringing cables, troubleshooting, etc., in remote operations.

Referring now to FIGS. 2C-1 and 2C-2, actuators 250 are provided for controlling the gantry 224. The actuators 250 may include an X-axis motor and driver 250A, a Y1 axis and driver 250B, a Y2 extension motor and driver 250C and a Z axis winch motor and driver and brake 250D. Motors may be provided for moving the various components of the gantry 224 such as the X mechanism 252A driven by the X axis motor and driver 250A which, in turn, drives the system in the X direction at 254. A Y1 mechanism 252B is driven by the Y1 axis motor and driver 250B and the Y2 mechanism 252C as driven by the Y2 extension motor and driver 250C. The Y2 mechanism 252C is the extension of cantilevered arm 230 illustrated in FIG. 2A. The gripper 236 is coupled to a Z 256 which, in turn, is coupled to the cantilevered arm 230.

Various sensors 258 may also be incorporated into the system, such as limits, switches and encoders 258A, one of which may be provided for each of the X, Y1, Y2 and Z directions. A load cell 258B may also be provided for the Z axis at the gripper 236. Likewise, a winch motor current sensor 258C may be provided on the winch motor 238 illustrated in FIG. 2A.

Controllers 260 may include a plurality of different types of controllers. Although specific models of controllers are illustrated, other types of controllers may be used herein. In this example, NVIDIA Jetson nano controller 262 is in communication with an Arduino pro controller 264 and a Nicla vision sensor hub controller 266.

The NVIDIA Jetson nano controller 262 serves as the central processing unit for computationally intensive perception tasks. The integrated NVIDIA GPU provides significant parallel processing power (CUDA cores), essential for accelerating the execution of deep neural networks (DNNs) used in modern computer vision tasks like object detection and segmentation, allowing for real-time inference speeds. The controller 262 running a full Linux operating system (via NVIDIA JetPack SDK) facilitates the use of standard development tools, libraries (OpenCV, PyTorch, TensorFlow, TensorRT), and frameworks like ROS (Robot Operating System), simplifying complex software integration and development.

The controller 262 offers a balance between computational capability, power consumption, and physical size suitable for deployment on a mobile platform drawing power from the trailer's battery energy storage system (BESS) or generator.

The Jetson controller 262 acts as the perception "brain," receiving sensor data (potentially pre-processed) from the Nicla Vision controller 266 and raw data from the Arduino Pro controller 264 (encoders, load cell). It performs sensor fusion, runs complex algorithms, interprets the scene, and provides the necessary perceptual information to the motion planning and decision-making modules. This contrasts with the Nicla Vision's potential edge processing role (simple, low-latency tasks) and the Arduino Pro's strict real-time motor control focus.

The perception system, leveraging the Nicla Vision controller sensors and the Jetson controller processing, performs several functions such as reel detection and localization. Cable reels 38 within the camera's field of view are identified and their precise 3D position and orientation relative to the gripper 236 is determined. This typically involves running a trained object detection model (e.g., YOLOv5/v8, SSD) on the Jetson controller 262 to obtain 2D bounding boxes of reels in the image feed from the Nicla Vision controller 266. Classical CV techniques like edge detection and Hough Circle Transform (using OpenCV) might complement the deep neural network (DNN) or trained classifier approach to find the reel's hub or circular features. The 2D position in the image is then converted to a 3D position relative to the camera using the camera's intrinsic calibration parameters and potentially depth information inferred from reel size or provided by the ToF sensor at close range.

The controller 262 precisely aligns the gripper's central axis with the target feature (e.g., reel hub center, secondary vehicle's spindle). A closed-loop control process where the Jetson continuously analyzes the Nicla Vision's camera feed. It calculates the positional error (offset in pixels) between the desired target feature and the current center of the gripper's view. This pixel error is converted into real-world X and Y₁/Y₂ motion commands using the calibrated camera model (hand-eye calibration). These commands are sent to the Arduino Pro controller 262 to move the axes, reducing the error iteratively until alignment within a specified tolerance (e.g., +/- 5mm) is achieved.

Obstacle detection is also performed by the controller 262 Identification of unexpected objects within the system's workspace or planned motion path to prevent collisions. The Jetson controller 262 runs object detection models on the Nicla Vision controller’s camera feed to identify generic obstacles (rocks, tools, debris, people). This is complemented by the Nicla Vision's ToF sensor, which provides direct distance readings for detecting close-proximity obstacles immediately in front of or below the gripper, acting as a crucial safety layer during descent or extension. Detected obstacles trigger motion halts or re-planning. Limitations include the camera's field of view and potential occlusions.

The system also performs secondary vehicle detection. That is, the controller 262 confirm the presence and approximate location of the target secondary vehicle (e.g., ATV) before initiating a reel transfer operation. The system is trained specifically to recognize the target vehicle types, running on the Jetson controller 262 using the Nicla Vision's camera feed. Challenges include variations in vehicle appearance, orientation, and distance. The system may define a specific "transfer zone" where the vehicle must be detected.

The controller 262 may also perform human occupancy detection to ensure absolute safety by detecting the presence of any person on or dangerously close to the secondary vehicle during automated reel transfer operations. This is a critical safety function. This process utilizes a highly reliable person detection model (e.g., YOLO variants, SSD trained extensively on diverse human poses and appearances) running on the Jetson controller 262, processing the Nicla Vision's camera feed. Challenges include partial visibility, varying clothing, different postures, and ensuring extremely low false-negative rates (failing to detect a person). Any positive detection must trigger an immediate halt and operator alert.

The controller 262 also is used to generate a dead reckoning aid (Visual Odometry). The controller 262 enhances the accuracy of the system's position estimate by using visual information to complement IMU and encoder data, particularly correcting for drift or wheel slip if the trailer moves. Techniques like tracking distinctive visual features (e.g., using ORB, SIFT, SURF algorithms in OpenCV) across consecutive camera frames from the Nicla Vision controller 266 allow the Jetson controller 262to estimate the camera's (and thus the system's) motion relative to the environment. This visual motion estimate is fused with IMU and encoder data in the EKF.

The Arduino Pro controller 264 serves as the dedicated real-time interface between the high-level commands from the Jetson controller 262 and the physical hardware of the motion system including the actuators 250 and the sensors 258. Its primary responsibilities require deterministic timing, typically achieved using timer interrupts or a tightly controlled main loop within its firmware.

Unlike the Jetson controller 262 running Linux, the Arduino Pro controller 264 guarantees execution of control loops and I/O handling within strict time bounds (e.g., every 1-2 milliseconds) to ensure smooth, stable motor control and immediate response to safety sensors. A closed-loop motor control is provided for each of the four axes (X, Y₁, Y₂, Z), the Arduino firmware implements a digital Proportional-Integral-Derivative (PID) control loop (or a similar advanced control algorithm). This loop continuously reads the current axis position from the corresponding motor encoder (requiring high-frequency quadrature signal decoding); compares the actual position to the target position/velocity setpoint received from the Jetson controller 262; calculates the error between target and actual state; computes a control output (e.g., a PWM duty cycle for DC/BLDC motors, or step/direction pulses for stepper motors) based on the PID gains (Kp, Ki, Kd) to minimize the error; and, sends the control signal to the appropriate motor driver.

The PID gains need careful tuning for each axis to achieve desired performance (responsiveness, stability, minimal overshoot) considering the varying loads and dynamics. The Arduino controller 264 directly interfaces with various low-level sensors 258. The controller 264 reads quadrature signals (A/B channels, potentially Index channel) from each motor's encoder for position feedback, and monitors digital inputs connected to the end-of-travel limit switches for all four axes. The firmware includes debouncing logic whereby upon activation, it can immediately inhibit motor movement in that direction and signal the event to the Jetson controller 262. The controller 264 reads data from the load cell amplifier (e.g., via SPI or I2C for an HX711 module), performs necessary conversions to obtain force/weight values, and handles tare commands from the Jetson controller 262. With respect to the motor current sensors, the controller 264 reads analog voltage or digital values from current sensors associated with the motor drivers (especially the Z-axis winch) for torque estimation and overload detection. The controller 264 also implements immediate, low-latency safety actions based on direct sensor inputs, operating independently of the Jetson's main loop. This includes halting motors upon hitting a limit switch or receiving an E-stop signal via a dedicated digital input.

The Nicla vision controller 266 is located at the end-effector (the gripper 236), its primary role is multi-modal data acquisition (image, IMU, ToF, audio). It performs essential sensor initialization, data timestamping, and potentially low-level filtering or edge ML pre-processing (as detailed in Section 3.3). It packages this rich sensor data for transmission to the central processing unit.

Although shown separately, the incorporates several key sensors, as part of the controller system. Each controller contributes unique data to the overall situational awareness.

A camera 266A is a color image sensor that provides the visual input necessary for machine vision tasks. This includes detecting and identifying reels, reading markers or labels, assessing reel fullness visually, detecting obstacles, recognizing secondary vehicles, performing person detection for safety checks, and providing visual feedback for precise alignment during pickup and placement operations. Frame rate and resolution are sufficient for real-time processing by the Jetson Nano controller 262.

An IMU (Inertial Measurement Unit) 266B is a 6-axis sensor combining a 3-axis accelerometer and a 3-axis gyroscope. The accelerometers of the IMU 266B measures linear acceleration (including gravity), while the gyroscope measures angular velocity. Together, they provide crucial data about the gripper's orientation (roll, pitch, yaw), detect vibrations, and measure dynamic accelerations during motion. This data is fundamental for sensor fusion, state estimation, and implementing advanced control strategies like active damping or adaptive input shaping.

An integrated digital microphone 266C captures ambient sound near the end-effector. While potentially challenging to use reliably in noisy outdoor environments, it offers the capability for acoustic event detection (e.g., listening for the 'click' of the gripper mechanism as a secondary confirmation, detecting impacts, or monitoring winch strain sounds) or potentially responding to simple voice commands during maintenance or testing phases.

A distance sensor 266D (Time-of-Flight – ToF sensor) measures distance directly by emitting an infrared light pulse and measuring the time it takes for the reflection to return. It provides accurate, short-range proximity measurements (typically up to a few meters, specific range depends on the sensor used). Its primary roles include detecting imminent collisions with objects directly below or in front of the gripper, precisely measuring the height above the ground or reel during Z-axis motion for contact detection and confirming separation after release.

A microcontroller 266E (STM32H747AII6 Dual core Cortex®-M7/M4) is an example of a powerful onboard processor capable of running firmware to manage the sensors, perform initial data conditioning (filtering, timestamping), and execute lightweight machine learning models directly on the edge (TinyML).

Connectivity (Wi-Fi/Bluetooth Low Energy) using a network interface 266F provides wireless communication capabilities, primarily useful for configuration, diagnostics, firmware updates, or potentially low-bandwidth telemetry, complementing the primary high-bandwidth wired connection (e.g., USB or SPI) to the Jetson Nano controller 262 for real-time data transfer.

Integrating these sensors into a single unit mounted on the end-effector offers significant advantages over using discrete, separately wired components. Co-location and data synchronization may also be manifested. All sensors share a common physical location and potentially a common clock source, ensuring that the captured data (e.g., image, IMU reading, distance) is spatially and temporally correlated. This greatly simplifies the sensor fusion process on the Jetson Nan controller 262, leading to more accurate state estimation.

Only a single communication and power cable needs to run from the main control system to the Nicla Vision sensor hub controller 266 on the moving end-effector, drastically reducing the number of wires needed compared to routing signals for a separate camera, IMU, distance sensor, etc. This improves reliability and simplifies maintenance by minimizing potential failure points in complex cable harnesses.

Placing the IMU 266B directly on the gripper 236 ensures it measures the actual orientation and motion of the end-effector, including any vibrations or swings, rather than the motion of a more remote part of the gantry structure. This is critical for effective input shaping and potentially active damping control.

The ToF sensor 266D provides immediate distance information relative to the gripper's viewpoint, crucial for fine control during the final stages of approach, engagement, and release, and for detecting close-proximity obstacles that might be missed by vision alone.

Platform power such as the from the power generation system 50 may be provided to the actuators cand the controller 260 (controllers 262-266).

A user interface 268 provides command to the system from the site operator. The signals from the user interface 268 are used to initiate processes and thee like subject to the safeguards provided by the sensors such as the presence of a vehicle, extension limits and proximity limits.

Referring now specifically to FIGS. 1A-3A, another subsystem of the overall platform is that a distributed private cellular wireless mesh network 19A may be formed. This subsystem provides the communications backbone for the deployment, enabling not only local connectivity (e.g. devices in the field connecting to the network associated with a particular mobile platform system 14 but also connectivity to the backhaul 19 to the outside world via multiple redundant links. In simpler terms, the platform 20 carries its own private cellular wireless network (like a mini 5G base station and core) that forms a cell 310 and can form a mesh network with other units or networking radios to ensure data gets where it needs to go. Each platform 20 forms a private wireless network (a first a second private cellular network in this example). Each private cellular network is joined by the link 17 and therefor a combine cellular private network comprising the first and second (and any further networks as illustrated in FIG. 1A may be formed. The system also employs sophisticated SIM and roaming technology to seamlessly switch between the private network and public carrier networks or satellite, depending on what is available. This networking subsystem is what makes the platform a fully standalone communications hub, often called a “network-in-a-box” but with extended range and resilience.

The system forms a private cellular network within each cell 310, for example, a 5G or LTE base station (Radio Unit) 44 and a local core network (possibly running on the platform’s compute hardware) operating in a band like the citizen’s broadband radio service (CBRS). The private networks from each of the two (in this example) systems 14 are not an island. That is the platforms themselves connect to each other or to other nodes via a multi-hop wireless mesh generally illustrated by signals 19A.

The backhaul 19 uses point-to-point or point-to-multipoint radio links. Traditional deployable “cell on wheels” (COW) units have a single backhaul link (like one microwave shot or satellite link) that links them to a main network. Here, multiple trailers can automatically form a mesh topology, relaying data through links to each other. This means if one trailer has a satellite link as a backhaul and another is in a spot with cellular coverage that is used as a backhaul, they can share connectivity to the backhaul and one can use the other’s backhaul should a connection be interrupted. This integrated design private cellular and mesh networking is a new and useful communication solution. Usually, a private LTE system without multi-hop backhaul, or a mesh network for data that is not directly tied into a 5G system is provided. Combining them yields a resilient network where each node (trailer/platform) is both a user-facing base station and a backhaul router.

The configuration of the mesh network allows multi-path, redundant backhaul with seamless failover. The subsystem uses multiple backhaul technologies concurrently e.g., line-of-sight radios (like 60 GHz or microwave) between trailers, possibly satellite links, and the ability to use public cellular networks if in range. An automatic, policy-driven failover between these links is used. The mention of “self-healing mesh” implies that if one link fails, routing protocols automatically send traffic via alternate paths to communicate through the public networks 312. The integration of multiple APNs/IMSI on SIMs (via Monogoto’s platform) means devices or the platform systems 14 can roam onto public networks seamlessly. For example, the system’s SIM can be accepted on Verizon or AT&T if the private network is out of range, without user intervention. A standard COW might have a satellite and a microwave as backup, but it typically would not mesh with peers or roam into public networks on its own. It is often a manual switch or a single failover. Here, the design anticipates an almost plug-and-play connectivity where the best available link is used at any time and trailers cooperatively extend coverage.

It is notable that two positions of backhauls 19 are illustrated, one in both cells and one in only one cell 310. Therefore, in the leftmost backhaul situation, the rightmost system 14 hops through the leftmost system to make a connection with backhaul 19. In the rightmost position, both systems 14 communicate directly with the backhaul 19.

Each system is equipped with one or more high-speed point-to-point radios – these could be directional antennas (like dish or panel antennas) using a technology such as 60 GHz millimeter wave or a lower microwave band if longer distance is needed. When the platforms/systems 14 are deployed, they can be pointed toward each other (perhaps manually or with an auto-align if advanced).

They establish a direct high-throughput link. If there are multiple trailers, they can form multiple interlinks: A connects to B, B connects to C, forming a chain or triangle, etc. They run a routing protocol over these links that makes it a mesh network – meaning data can hop from one to another. If one link breaks (say Trailer B to C line of sight is lost because a truck parked in between), the routing protocol finds another path (maybe A to C via A-B then B-A then A-C, if multi-hop works, or via an alternate frequency).

This is “self-healing” because the network automatically adjusts. In effect, the trailers create their own ad-hoc network, independent of any existing infrastructure. The document referenced using their own 5G radios for this interconnection, which suggests they might even be using the same cellular radios to directly link trailers (like using 5G sidelink or a built-in feature). Or they might simply treat the private 5G as providing local access and use a separate dedicated mesh radio for trailer-to-trailer. The exact method can vary, but the result is the same: a redundant backhaul network among the deployed units.

As mentioned above, each system may include edge computing for core network and services. The system 14 on the platform 20 carries the onboard compute controller 106 of FIG. 1D that runs the private 5G core network (for handling SIMs, authentication, etc.) and possibly local services Combined with the above, it means each system is self-sufficient yet can join others. A special feature is that multiple such trailers can join to form a larger private network domain effectively forming a distributed core. One could deploy, say, three trailers over a big area; each has its cell 310, and they link up via mesh to act as one network, sharing a common core via that mesh. This is more dynamic and distributed than prior solutions. Traditional private networks are usually one central unit and maybe remote radios, but not fully peered equals that mesh together. The documentation explicitly notes “ability to deploy multiple such units that automatically form a larger mesh network” which is a novel deployment model.

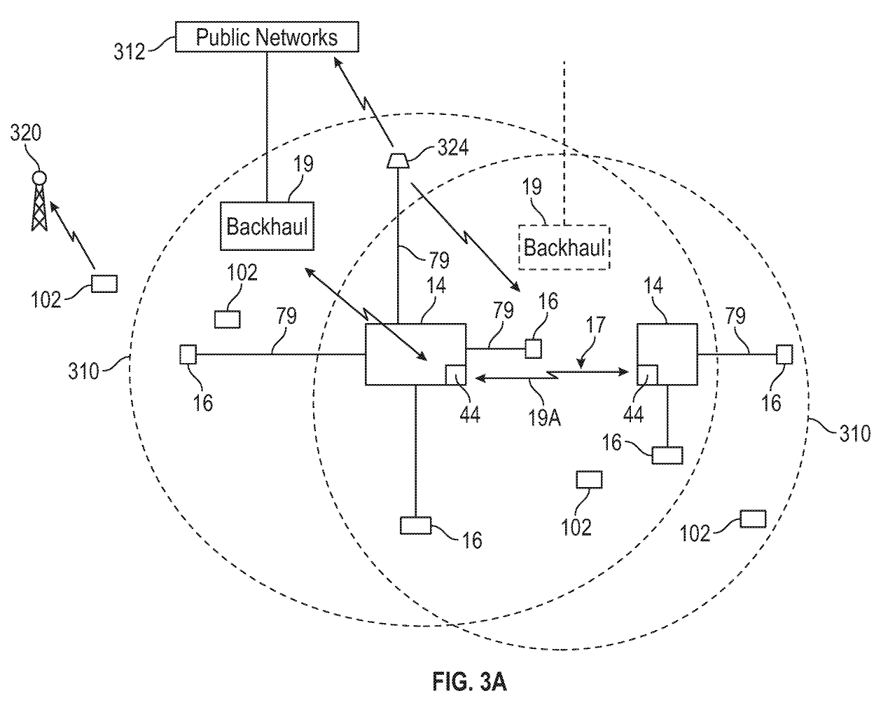

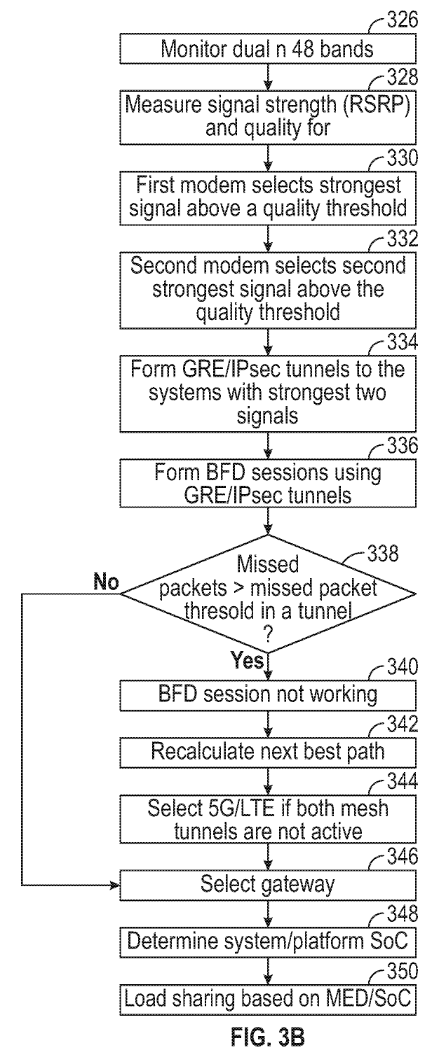

The system may use Monogoto’s multi-APN, multi-IMSI SIM management is a bleeding-edge feature. It allows devices on the private network 19A to roam onto public networks or vice versa with proper policy. For instance, the mobile device 102 could use the private 5G of the nearest system 14, but if it leaves range, that same SIM can connect to a commercial carrier 320 as illustrated at the left side of FIG. 3A. The system’s cloud will treat it appropriately (perhaps for backup or extended connectivity).

Typically, private network devices are “stuck” on that network unless they have two SIMs or manual reconfiguration. By integrating this from the start, a continuous connectivity that follows users or machines as they move in and out of the coverage of a system 14.

Overall, while mesh networks and private LTE systems exist, the particular combination and autonomy of this network subsystem improves the field of communications. Conventional COWs provide cellular coverage but “backhaul resilience” for them is typically limited, and they do not form meshes with each other automatically (each is usually independently linked to a network). This subsystem appears provides no single point of failure in communications by using every available wireless avenue in tandem.

The system 14 also has interplay with the power subsystem because the system 14 can lay hybrid fiber cables, it could place remote radio units far out. Alternatively, RUs 44 and edge enclosures may be positioned away from the main platform using the hybrid cable 79. This means the mesh network may be more than platform to platform. A platform may also drop a wired tethered node 324 (like a small cell on a hilltop) to act as a mesh relay to another coverage cell.

Referring now to FIG. 3B, as mentioned above self-healing mechanisms may be implemented. A process for initial neighbor discovery and initial path selection is set forth. In step 326, the dual modems within each system radio unit 44 continuously monitor the n48 CBRS band. The RUs 44 perform periodic scans (such as specified interval: 5 seconds) of configured EARFCNs (frequencies) within Band n48.

In step 328, the signal strength (RSRP) and quality (RSRQ, SINR) of detectable cells broadcast by RUs of neighboring systems 14 is determined at all the systems 14.

In step 330, first modem selects the neighbor cell/system 14 providing the strongest suitable signal (above a predefined quality threshold) as its primary attachment point. In step 332 the second modem simultaneously selects the next strongest signal, from a different neighbor cell/system 14 as its secondary attachment point. This establishes the initial primary (metric 10) and secondary (metric 20) Generic Routing Encapsulation/Internet Protocol security (GRE/IPsec) tunnel paths (p5g0, p5g1) to the two highest strength systems 14 for the dynamic routing protocol in step 334.

In step 336, rapid failure detection Bidirectional Forwarding Detection (BFD) sessions are established over both active GRE/IPsec tunnels (p5g0 and p5g1) connecting to the primary and secondary neighbor systems 14. This is performed by exchanging BFD control packets at a high frequency (such as: 1 Hz).

If a specified number of consecutive BFD packets (specified: three) are missed on a given tunnel, the BFD session is declared down in step 340. This indicates a likely failure of that specific mesh link.

The BFD state change immediately triggers the local dynamic routing protocol (BIRD/Quagga) on the Moxa MRX-G4064 switch. The route metric associated with the failed path (e.g., via p5g0) is automatically increased by a significant amount (e.g., +50).

This metric change forces the routing protocol to instantly recalculate the best path, selecting the secondary mesh tunnel (e.g., via p5g1) if it is still active in step 342, or initiating fallback to public LTE/5G if both mesh tunnels are down in step 344. The BFD integration allows for much faster failure detection and traffic convergence (potentially sub-second) compared to relying solely on slower routing protocol hello timers or convergence mechanisms. The advantage of using 5G/LTE technology instead of, just Wi-Fi is range and reliability. Cellular signals, especially sub-6 GHz like CBRS, can cover larger areas and handle many devices with robust handoff and scheduling algorithms. It is also good for moving devices (vehicles, drones) that might roam around the site.

In step 346 dynamic gateway selection is performed and load sharing/internal border gateway protocol (iBGP) may also be used. Platforms/systems 14 may be connected to a site fiber WAN interface via their ONT 21 function as internet gateways for the mesh.

The connected gateway trailers advertise a default route (0.0.0.0/0) to their mesh peers using iBGP running on the MRX-G4064 switches. A gateway selection is made dynamically and are power-aware. The BGP configuration utilizes attributes linked to the systems/platform’s BESS State of Charge (SoC), which is monitored by the local PLC/management system and communicated to the switch in step 348. A primary selection is made by systems 14 with a high SoC (e.g., > 80%) that advertise the default route with a high BGP Local Preference value. Routers prioritize routes with higher Local Preference, ensuring traffic defaults towards the healthiest gateways.

Load sharing is performed in step 350. If multiple gateways have similarly high SoC, the BGP Multi-Exit Discriminator (MED) attribute is used for finer-grained preference. MED is set inversely proportional to SoC (lower MED for higher SoC). Routers prefer lower MED values when comparing routes from the same neighboring autonomous system (in iBGP, this applies to routes learned from different peers within the mesh), effectively distributing the outbound WAN load across multiple healthy gateways. The intelligent routing policy ensures that WAN traffic load is directed towards trailers with the most available power, enhancing overall fleet resilience and operational duration when off-grid.

Other functions may also be built into the systems such as public carrier fallback in a software defined wide area network (SD-WAN). This provides more details to step 344. When the BFD detects failures on both the primary (p5g0) and secondary (p5g1) private mesh tunnels, and this state persists for a defined duration (specified: >15 seconds). This indicates isolation from the private mesh network. The mobile platform system 14 initiates fallback to public cellular networks. The modems detach from the private n48 PLMN and attach to configured public LTE/5G carriers. The LinkFusion SD-WAN router/functionality activates, establishing bonded tunnels over the two public cellular links (lte0, lte1). The dynamic routing protocol sees the mesh routes become unavailable (high metric or withdrawn). The default route automatically shifts to use the bonded SD-WAN interface, which has pre-configured metrics (e.g., 30 and 40) lower than the penalized mesh routes but higher than the preferred mesh routes.

Satellite Rescue (NB-IoT NTN Out-of-Band) may also be used when all IP-based communication paths fail. That is, when both private mesh tunnels and both public LTE/5G connections are down satellite may be used. The GNSS Telemetry Daemon detects inability to reach the NOC MQTT broker via any IP route. The daemon switches communication to the Skylo S2000 NB-IoT NTN modem 105. To provide a beacon, the satellite periodically transmits essential telemetry (primarily GPS location JSON payload) over the satellite NTN link. This ensures the network operation center (NOC) maintains situational awareness of the platform/system 14 location even when completely isolated.

The NTN link allows for very low-bandwidth, high-latency command transmission from the NOC back to the system 14. This can be used for critical "rescue" operations, such as instructing the V3200 or an integrated PDU to reboot the primary radios (Comba RU, SailaDome) or cycle power to specific subsystems in an attempt to restore IP connectivity. The NTN channel provides a vital lifeline for asset tracking and basic remote intervention during catastrophic communication failures.

Power-aware traffic pruning may also be performed. The local trailer's BESS management system reports SoC falling below a critical threshold (e.g.: 30%). The local Moxa MRX-G4064 switch 14 dynamically adjusts its iBGP advertisements to mesh neighbors. It significantly lowers its advertised BGP Local Preference value. Therefore, neighboring systems’ routers, preferring higher local preference values, will no longer see the low-battery trailer as an attractive path for transit traffic (i.e., traffic not originating from or destined to the low-battery trailer itself). This traffic automatically reroutes through other, healthier neighbors with higher advertised local preference. This mechanism actively sheds transit load from critically low-battery trailers, preserving their remaining energy for essential local functions (e.g., running the 5GC, the local RU sector, or critical sensors) and extending their operational lifespan within the mesh. It complements the gateway election logic by addressing transit traffic, not just WAN-bound traffic.

One advantage of the system is the backhaul using mesh networking between trailers. When multiple platforms or systems 14 are spread out (maybe across a large construction site or along a path in a forest for a search-and-rescue mission). Each has its own cellular coverage bubble. They all may be connected so that a user connected to Trailer A can communicate with a user connected to Trailer B, and so that only one of them needs a satellite uplink to reach the internet, and the others can piggy-back off it. This is where the mesh backhaul provides a versatile advantage. In a particular large area, the adjacent systems may be related and effectively one large interconnected private communication system is formed.

The system of systems 14 may be configured in various ways. Each system 14 may provide multi-WAN and roaming connectivity. That is each platform/system 14 can also have other backhaul methods such as A satellite terminal (e.g., a VSAT or Starlink dish). To provide a way out to the internet or a command center anywhere on earth, though with latency.

A connection to public cell networks may be provide through a modem that can connect to 4G/5G from Verizon/AT&T if available. This could be used if, say, the systems 14 are augmenting an existing network rather than in complete wilderness. Ethernet or fiber may be used if at a base camp.

The system is designed to juggle these. It can use the high-speed mesh between trailers to share whichever one has the best uplink. For instance, Trailer A might have satellite, B might catch a weak 4G signal to a distant tower, and C has nothing. The network might route all traffic from B and C to A to go out via satellite, but if A’s satellite goes down, maybe B’s cellular link can take some traffic and route it back to C. This is achieved by having a router in each trailer that does load-balancing and failover mentioned above. They likely set up a VPN or similar between trailers so that all data can be encrypted and passed around securely regardless of path.

SIM management and roaming may be used to provide versatility to the system and the devices therein. Consider devices 102 (e.g. a field tablet) connected to system A’s private 5G. Normally, that tablet’s SIM is only known to the private core. But what if the person walks out of range of Trailer A with the device. The SIM in that tablet could also be recognized by a public network. Using a platform such as Monogoto’s platform, the SIM can have multiple profiles or be allowed on partner networks. So, if that person wanders where there is commercial coverage but no trailer, the tablet switches and registers on, a cellular provider’s system such as Verizon, using a secondary profile. Monogoto’s core knows it is the same device and can perhaps tunnel its data back to the user’s network or at least keep track of it. This way, the coverage area is extended virtually using existing carrier networks. Conversely, if a responder comes with their normal phone (Verizon SIM) into the trailer’s coverage, the system might use a technology like neutral host networking (CBRS can allow a private network to host public carrier subscribers if configured). Or simpler, the responder’s phone stays on Verizon, but the trailer has a micro cell for Verizon as well (less likely unless arrangements are made). The easier scenario is with custom devices that all have the special SIMs that prefer the trailer’s network but can roam out.

From an engineering perspective, this means the trailer’s core network is somewhat federated with the cloud. The Monogoto platform likely runs in the cloud and the trailer connects to it, or a slice of it runs on the trailer. It is beyond a typical deployment, showing the inventors worked out how to make private and public networks cooperate. Advantageously in emergency scenarios, no single point of failure in communications is provided by this system. If the satellite fails due to weather, a ground cell may still work; if one trailer goes down, others still talk. The mesh ensures that even if, say, one trailer’s backhaul is out, it can route through a neighbor. Traditional solutions often had just one link. If that link failed, that system 14 is off-grid. Here, redundancy is provided at multiple layers (radio link redundancy, and roaming to different networks) by providing dynamically routed communications over a multi-hop, multi-link network with automated failover. That is a mobile communication node with a private cellular access and at least two distinct backhaul transceivers are provided for failovers with key differentiators such as private network integration, mesh capability, multi-network SIM.

To illustrate, suppose these trailers/platforms/systems 14 are used in a large wildfire incident. Firefighters around each trailer use smartphones connected to that systems 5G connection. The system 14 and adjacent systems form a mesh and one of them has a Starlink satellite dish sending everything to the internet. If that dish’s link is disrupted (satellite drop or power issue), the system might detect loss of connectivity and instantly switch to using an LTE connection that one trailer has to a distant cell tower on the horizon. The firefighters likely notice nothing. Their data radios may see a slight slowdown but continue working. This automatic resiliency is a big selling point and an inventive aspect.

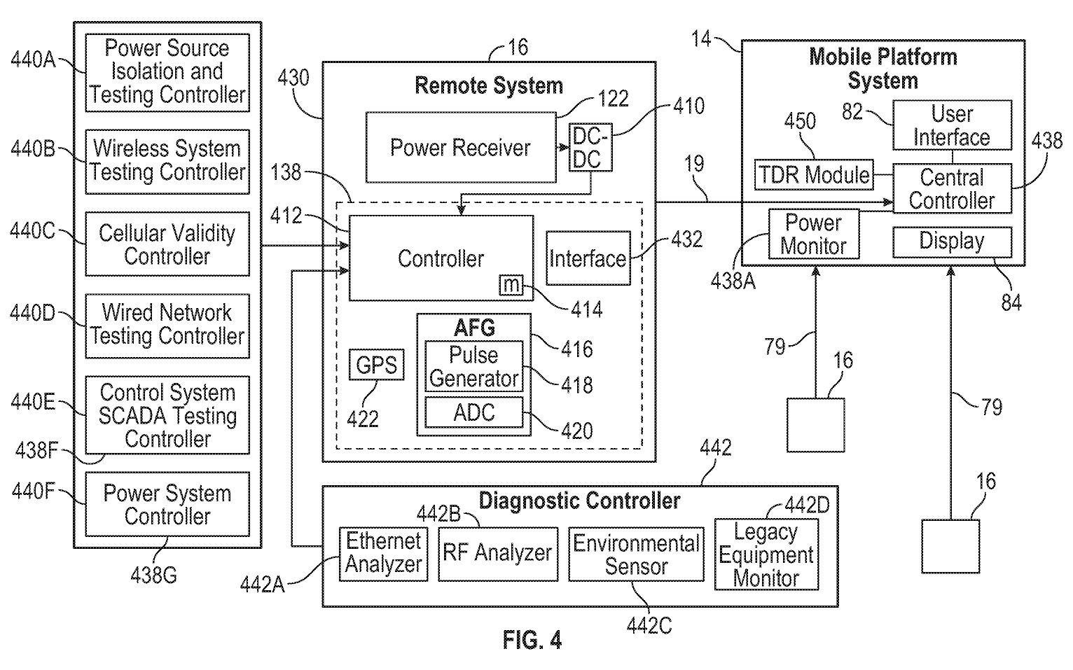

Referring now to FIG. 4, another feature off the present system is distributed diagnostic for external Infrastructure using distributed Time Domain Reflectometry (TDR) and edge diagnostics. This subsystem focuses on testing and monitoring external infrastructure, such as existing cables, lines, and equipment in the field, using the resources of the mobile platform. The TDR subsystem uses distributed (TDR) measurements via remote test nodes to locate faults in cables (power lines, communication cables, pipelines with sensor wires, etc.). In addition, the diagnostic system can interface with other equipment (radios, network devices, PLCs) near where the remote endpoints are deployed, providing a broad suite of tests (protocol pings, RF tests, etc.). The innovation lies in making what is normally a labor-intensive, one-point-at-a-time testing process into a coordinated, multi-point automated diagnostic network that travels with the platform/system 14.

The present system uses multiple distributed TDR test nodes working together. Traditional TDR devices are standalone instruments connected to one end of a cable to measure reflections and find faults. Here, the multiple TDR units (one at each of multiple remote endpoints, plus possibly one at the trailer) are used to perform tests simultaneously or in a coordinated fashion on a cable network Test nodes may be attached at different access points of, say, a long pipeline communication cable or a perimeter of sensors, and by injecting signals from multiple ends, faults may be pinpointed with greater accuracy (even triangulating their location via multiple reflection arrival times). This distributed TDR approach set forth herein is a system with TDR modules scattered in the field all centrally coordinated.

Remote powering and networking of test devices is provided in the system. These TDR/test nodes are powered by the Class 4 power distribution (i.e., they are the “briefcase” endpoints fed by the hybrid cable). This allows placement of test instrumentation far from the main unit without local power or batteries. So effectively, the system can deploy test probes over a 2 km radius. Those probes (endpoints) communicate back over the fiber or wireless network, sending raw data to the central trailer. Traditional TDR usage does not have this. A TDR is typically moved to each location. The improvements include the combination of remote powering and remote testing. An integrated solution that “lights up” existing infrastructure with monitoring capability on the fly.

More specifically in FIG. 4, a high level view of the components of the TDR aspects of the remote system is set forth. TDR edge device incorporates the power receiver 122 such as the VoltServer Digital Electricity receiver module. In this example the approximately 336V DC input from the conductors of the hybrid cable 79. An onboard DC-DC converter steps down the received high voltage to the low voltages required other components. This eliminates the need for local batteries or power wiring at each sensor location. A Time Domain Reflectometer TDR device is like a radar for cables. It sends an electrical pulse down a cable and “listens” for reflections. If there is a change in impedance (like a break, a short, or a splice) along the cable, part of the pulse energy bounces back. By measuring how long it takes for the reflection to return, how far down the cable the irregularity is may be estimated (since signal speed in the cable is known). Traditional TDRs are used by plugging them into one end of a cable. If only have one end is accessible, it is single-ended TDR. If both end are accessible, a test from each end may be performed.

The TDR device 138 has a central controller 412 utilizes a capable, low-power processor like the Arduino Portenta C33 providing sufficient processing power for TDR signal generation, sampling, basic analysis, and communication. The central controller 412 is associated with a memory 414 that is a non-transitory computer readable medium that includes machine-readable instructions that are executable by the processor for 12. The instructions may be implemented in and manages the TDR measurement cycle, triggering the pulse generator, sampling the reflected waveform via the ADC, processing the raw data (e.g., filtering, feature extraction), and associating it with the current GPS time and location.

The remote system 16 has an analog front-end (AFE) 416 that may be implemented in a custom printed circuit board including a fast-rise-time pulse generator circuit 418 (to inject sharp pulses into the cable) and a high-speed sampling circuit (ADC) 420 with appropriate signal conditioning (amplifiers, filters) to capture faint reflections accurately . Impedance matching in the amplifiers/filter may be used for clean pulse injection.

The remote system may also include a global positioning module 422 An integrated GNSS receiver provides precise location coordinates (latitude, longitude) and access to accurate time (e.g., via GPS PPS signal) for timestamping measurements. The remote system 16 may also be housed in an enclosure 430. The enclosure 430 is a compact, rugged, DIN-rail mountable industrial enclosure suitable for field deployment. GPS time provides a highly accurate common time reference across all distributed TDR nodes, enabling coherent analysis of measurements taken at different locations.

The processed TDR data packets (waveform segments or extracted features, plus metadata) are transmitted back through the optical fiber portion of the hybrid cable using standard network protocols (e.g., TCP/IP, MQTT). Error handling for temporary connectivity loss (buffering/retry) may be implemented.

An interface 432 may be used to connect the remote system to the mobile platform system. The interface 432 allows communication of the data through the optical fiber portion of the hybrid cable 79.

An industrial PLC (e.g., Moxa ioPAC 8600 series) acts as the primary real-time central controller 438 in the mobile platform system 16. Automation sequences (deployment prep, mast operation, retrieval sequences like respooling control and pick-and-place restocking), power management strategies (generator auto-start/stop, load balancing/shedding), safety routines (emergency stops, fault interlocks), and environmental control (HVAC management ) may be performed.

System self-diagnostics includes a power monitor 4438A continuously monitors the Class 4 power channels (voltage, current, faults), battery health via BMS, generator status, network link status (wired and wireless), compute resource utilization, and environmental conditions within the trailer.

The distributed TDR system provides detailed, continuous monitoring of the deployed hybrid fiber-power cables, enabling detection, localization, and classification of physical cable faults (opens, shorts, degradation).

One innovation lies in leveraging the highly configurable remote endpoint modules as distributed test heads for diagnosing existing third-party equipment located near the endpoint deployment site. By integrating specific diagnostic instruments or interfaces into the modular endpoint payload area and utilizing the endpoint's reliable Class 4 power and high-bandwidth fiber backhaul, the system can perform remote testing that previously required manual site visits with specialized gear as set forth below.

A power source isolation and testing controller 440A is provided. When troubleshooting field equipment like a Supervisory Control and Data Acquisition (SCADA) radio with multiple power inputs (e.g., DC and PoE), the endpoint TDR 138 can provide isolated power via either its DC output or its power on Ethernet (PoE) port, bypassing the potentially faulty existing power source. This allows remote determination of whether the device failure is due to its internal power circuitry or the original power feed (e.g., diagnosing of a radio's DC input was damaged by a surge while its PoE input remains functional).

The remote systems 16 may be referred to an endpoint. A wireless system testing controller 440B may also be provided. The endpoint TDR 138 may be configured with an RF spectrum analyzer or antenna analyzer (e.g., SWR meter)that can connect to existing radio antennas (UHF, VHF, Cellular, Wi-Fi) to test for damage (e.g., lightning strikes, physical breaks), performance degradation (e.g., high SWR indicating feedline issues), or interference issues within the operating band. Local wireless interfaces (Wi-Fi, BT) on the endpoint can also probe connectivity and signal strength of nearby wireless devices.

A cellular connectivity validation controller 440C for diagnosing issues with field equipment like a cellular radio in a SCADA box may be provided. The system offers multi-pronged testing. First, the endpoint can power the radio (via PoE or DC) and monitor its network connection status (e.g., registration, signal strength reported by the radio) via its data interface (Ethernet, serial). Second, the central mobile platform, using its own backhaul (potentially including cellular via Monogoto/SailaWave), can independently assess public cellular network availability and performance in the area, distinguishing between a faulty radio/antenna and a broader carrier outage. Third, using an RF diagnostic module at the endpoint connected to the radio's antenna feedline, tests such as SWR measurements can identify physical antenna or cable damage (e.g., from a lightning strike) that might prevent the radio from communicating effectively even if the radio itself and the cell tower are functional.

A wired network testing controller 440D may be implemented in the remote system 16 (endpoint). Ethernet or fiber ports can be used to run network diagnostic tests (e.g., ping, throughput tests using iperf, packet capture analysis, OTDR tests on external fiber runs if equipped with an OTDR module) on connected field switches, routers, or other networked devices.

A control system (SCADA) testing controller may also be implemented in the TDR 138. Endpoint serial (RS-232/485), CAN bus, or Ethernet interfaces can connect to existing PLCs, RTUs, or other controllers in SCADA cabinets to execute diagnostic commands, check responsiveness, verify communication integrity, or identify potential hardware failures (e.g., detecting a non-responsive "fried" PLC potentially caused by power surges).

A power system testing: controller 440F may also be included in the TDR 138. While primarily delivering power, endpoints could incorporate power quality monitoring modules or specific load testing capabilities to diagnose issues with the power inputs or supplies of connected field equipment.

Data from all the controller 440A-440F are communicated through the hybrid portion of the hybrid cable 79. Although the details for other mobile systems 16are not illustrated, each can be configured in a similar way.

The mobile platform system 14 and, in particular, the central controller 438 performed centralized AI-driven analysis of field diagnostics. The system aggregates data from these distributed tests at the central controller 438 with AI-based analytics. Analysis (potentially machine learning) is used to interpret TDR waveforms and other sensor readings in real-time to classify faults, predict failures (maybe by recognizing patterns that precede a fault), etc. While some advanced TDR analysis algorithms exist academically, a mobile platform that does AI on field diagnostics data is new. The concept of feeding multiple TDR results into a central AI that can cross-correlate them is a fresh approach to cable diagnostics.

The remote systems 16 are not limited to TDR. The controller 412 may have a diagnostic controller 442 that can host other instruments or interfaces that obtain diagnostic date from, e.g., an Ethernet analyzer 442A to plug into an existing switch, a radio frequency analyzer 442B to test an antenna, or environmental sensor 442C for environmental data such as temperature, wind speed and humidity. The versatility is unmatched. The same distributed platform can perform various kinds of tests on legacy equipment. For instance, an endpoint could plug into a remote PLC’s maintenance port and run diagnostics, all while being powered by the trailer’s cable. There are systems that do remote monitoring, but those are usually purpose-built (like a dedicated pipeline monitor). Here we have a general-purpose diagnostic toolkit that may be brought to the site and connect into whatever needs testing. The system’s integration means these various tests can run concurrently and be time-synchronized or centrally managed.

Legacy infrastructure may also be monitored at the legacy equipment monitor 442D. Many test systems focus on newly installed systems (e.g., commissioning tests) or are permanently installed monitoring on known infrastructure. The deployable diagnostic system may also be aimed at existing, possibly decades-old infrastructure that normally does not have built-in monitoring. It is like bringing an entire lab to the field.

Challenges in Complex Cables: If a cable has branches (like a T-junction where another cable splits off) or multiple small faults, interpreting a single TDR trace gets tricky. Reflections overlap or come from multiple paths, and small impedance changes (a slightly frayed cable) might not reflect strongly, getting lost in noise. This is where having multiple test points helps. The mobile platform system 14 may have TDR module 450 as well to allow injection of pulses from different sides or measure reflections at multiple points which gives more angles on the problem.

The distributed TDR in this system improves existing systems. By way of example if an existing cable network in the field such as communication cable running between several oil well pads with spur lines going to each well. Normally, if something is wrong (a sensor lost connection), a technician might have to drive to each segment with a handheld TDR to find where the break is. With this system, endpoints may be deployed at various access points. For instance, deployment may be at one end of the main cable, at the other end (if accessible), and maybe at a midpoint if there’s a junction box, etc. These endpoints are each equipped with a small TDR circuit. They connect physically to the cable (via a port or clip). A method may therefore be performed to test such a cable. Each endpoint sends a pulse at a coordinated time (or one after the other in a known sequence) down the cable. Each endpoint also listens for pulses, including those coming through the cable from other endpoints’ pulses. The sent and received signals are timestamped by using a common reference (GPS clocks give all devices the same time base to within, say, <50 ns). The raw timing data is sent back to the central server of the mobile platform system.

The server now has multiple “views” of the cable. For example, endpoint A at one end saw a reflection 20 microseconds after its pulse – which suggests a fault ~2 km away. Endpoint B at the far end saw a reflection 5 microseconds after its pulse – maybe the same fault but from the other side, indicating it’s ~500m from B’s end. By combining these, the server deduces the fault is at a specific location along the cable, perhaps 1.5 km from A and 0.5 km from B (consistent with those times). If there is a branch, maybe an endpoint on the branch also sees something, helping identify if the fault is on the branch or main line.

In essence, triangulation is used much like GPS locating a position by using multiple satellites – here instead of “satellites” the test pulses are generated from different points. This gives a much clearer picture than one perspective alone. It also helps with “soft” faults – small impedance changes – because even if A’s reflection is tiny, B might see a bigger one, etc. The central AI or algorithm can piece together these subtle clues.

Beyond the individual subsystems (power, cable handling, network, diagnostics), the system significantly improves various aspects of mobile infrastructure systems. Various aspects are combined, each enabling and enhancing the others. The combined system is more than just a sum of parts; it is an ecosystem-in-a-box that addresses a wide array of field needs simultaneously. Many of the individual novel features actually rely on the presence of the others to reach full potential. The synergy is a strong between the components. The integrated system achieves capabilities that none of the subsystems could alone. Some key synergies include power system enabling remote network and diagnostics. The long-reach power allows the network coverage to extend physically – e.g., by placing remote radio heads or mesh nodes far from the trailer via cable. It similarly allows diagnostic endpoints to be placed at needed locations (e.g., along a pipeline) which would be impossible if they all had to be battery powered or manually attended. This means remote power is an enabler the other two main aspects bringing their functionality to a much larger radius. The combination yields a field-deployable network that is not limited by line-of-sight or short wireless range because wired links can be dropped, and a field diagnostic system that can reach places with no power. Prior art may be a network trailer, but a far-away radio could not be powered without local generators or having a cable tester but needing power at multiple ends. The integration is novel and non-obvious as a whole because it creates a self-sufficient network of devices across a wide area.

Network system coordination is provided. The mesh network ensures that all parts of the system (including the distributed endpoints and even the robotic cable handler via remote tablet control) stay connected reliably. For instance, the diagnostics endpoints need to send data back; the mesh provides redundant paths for that. Also, the user might be using the private cellular to remote-control the deployment (the operator’s tablet connected to the trailer’s 5G) to move the robot arm or start tests. Without the advanced network, the power system and diagnostics would be more limited (imagine if the backhaul failed, the remote TDR data or camera feed may be lost. This adds resilience and an in-band control channel for the entire operation, making the system easier and safer to use (e.g., an operator can stand near an endpoint and still have a connection to the main trailer through the private network). This synergy of having a robust network plus the other capabilities is not found in prior singular-purpose systems (e.g., a generator trailer does not usually have any comms; a test van might not have its own network). The inventors saw that to truly be a drop-in solution, connectivity between all pieces had to be guaranteed.

Diagnostics provide feedback and intelligence to the system. The diagnostic subsystem can also monitor the health of the system’s own deployed assets, not just external ones. The integrated design mentions “integrated diagnostics for system health.” For example, the system could use TDR on its own power cables to check if a deployed cable got damaged (since TDR may be used on a systems’ own hybrid cable to know if it has been cut or stressed at some point along the run). It can also check field equipment that the system is powering (e.g., a remote radio is powered via the cable, the remote system 16 run tests on that radio periodically). This introspective capability means the system is semi-autonomous in making sure both it and the environment are operating well. Competing solutions require human checks or do not have any self-test. The synergy here is that because power and network are there, monitoring the system is enabled. Further because diagnostics are distributed, power distribution points may be embedded. Again, a holistic design decision that improves reliability and reduces the need for extra instruments.

The physical design of the trailer needed to accommodate all this gear including power electronics, spools, masts for antennas, etc. The integration itself in a constrained form factor required innovation (like shock mounting the server rack, balancing the trailer weight with the battery placement vs. the crane, etc., which presumably is in mechanical design docs). The system is a true synergistic integration... onto a single mobile platform.”

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A mobile infrastructure system comprising:
a plurality of mobile devices;
a plurality of remote systems having a diagnostic controller; and
a transportable platform in communication with the plurality of remote systems with a hybrid cable comprising an optical fiber and an electrical conductor, the transportable platform comprising,
a fault-managed power generation system coupled to the transportable platform;
a robotic cable management system coupled to the transportable platform, the cable management system comprising a vision-guided reel handler retrieving a plurality of cable reels each comprising the hybrid cable;
a cable diagnostic system receiving data from the diagnostic controller; and
a controller forming a first cellular wireless network with the plurality of mobile devices, operating the cable diagnostic system and controlling distribution of power through the hybrid cable.

2. The mobile infrastructure system of claim 1 wherein the transportable platform comprises wheels.

3. The mobile infrastructure system of claim 1 wherein the transportable platform is transportable by an aircraft.

4. The mobile infrastructure system of claim 1 further comprising a mast coupled to the transportable platform, wherein the mast forms the cellular wireless network with the plurality of mobile devices through the mast.

5. The mobile infrastructure system of claim 4 wherein the mast comprises a motor-driven telescoping mast.

6. The mobile infrastructure system of claim 1 wherein the power generation system comprises at least one of a diesel power generator, solar power generator and a hydrogen power generator.

7. The mobile infrastructure system of claim 1 wherein the power generation system comprises a plurality of batteries.

8. The mobile infrastructure system of claim 1 wherein the power generation system comprises a Class 4 power system.

9. The mobile infrastructure system of claim 1 wherein the power generation system comprises a power transmitter kilometer-scale distribution through electrical conductor of the hybrid cable.

10. The mobile infrastructure system of claim 9 wherein the power generation system comprises a power receiver disposed in at least one of the remote systems.

11. The mobile infrastructure system of claim 10 wherein the power receiver converts a first DC voltage to a second DC voltage.

12. The mobile infrastructure system of claim 1 wherein the diagnostic controller triggers a pulse generator to communicate a pulse into the hybrid cable, sampling a reflected waveform at an analog to digital converter and, processes raw data, and associating the raw data with a current GPS time and location.

13. The mobile infrastructure system of claim 12 wherein the controller communicates the raw data, the GPS time and location to the transportable platform through the optical fiber.

14. The mobile infrastructure system of claim 1 wherein the diagnostic controller comprises at least one of an Ethernet analyzer to plug into an existing switch, a radio frequency analyzer to test an antenna, and an environmental sensor.

15. The mobile infrastructure system of claim 1 wherein a controller forms a private cellular wireless network with the plurality of mobile devices.

16. The mobile infrastructure system of claim 1 wherein the cable management system comprises a plurality of reels of hybrid wires and a frame.

17. The mobile infrastructure system of claim 16 wherein the cable management system comprises a camera for aligning a robotic gripper with a first reel of the plurality of reels.

18. The mobile infrastructure system of claim 16 wherein the cable management system comprises a camera, a time of flight sensor, and an inertial measurement unit for aligning a robotic gripper with a first reel of the plurality of reels.

19. The mobile infrastructure system of claim 18 wherein the cable management system comprises a cantilevered arm coupled to the gripper for moving the gripper outside the frame.

20. The mobile infrastructure system of claim 18 wherein the cable management system comprises a cantilevered arm coupled to the gripper for moving the gripper laterally outside the frame.

21. The mobile infrastructure system of claim 1 further comprising a backhaul.

22. The mobile infrastructure system of claim 21 wherein the backhaul comprises at least one of a cellular backhaul, a microwave backhaul, and a satellite backhaul.

23. The mobile infrastructure system of claim 21 further comprising a second transportable platform comprising a second controller forming a second cellular wireless network, the first cellular wireless network and the second cellular wireless network forming a mesh network.

24. The mobile infrastructure system of claim 21 further comprising a second transportable platform comprising a second controller forming a second cellular wireless network, said first cellular wireless network and the second wireless network forming a private cellular wireless network.

25. The mobile infrastructure system of claim 24 wherein the first cellular wireless network and the second cellular wireless network form a first link for communicating backhaul data to communicate data from the second cellular wireless network and when the first link does not exist communicating the backhaul data to the backhaul through a second link.

26. A mobile infrastructure system comprising:
a trailer including wheels;
an electrical generator located on the trailer;
a battery located on the trailer and being connected to the generator;
at least one cable comprising an optical fiber and an electrical conductor, the at least one cable being at least partially located on the trailer and being connected to at least one of: the battery or the generator;
a mast antenna located on and upstanding above the trailer, and the antenna being connected to a cellular wireless network;
a controller located on the trailer and being configured to control a distribution of electrical power through the at least one cable; and
a multi-directional wireless backhaul network being configured to use aggregated public cellular or dedicated communication frequencies in order to establish simultaneous links with multiple neighboring nodes or available public networks, the links forming a dynamic mesh topology configured to allow data traffic to be automatically rerouted through alternative paths when any single link or node fails.

27. The mobile infrastructure system of claim 26 wherein the controller is configured to: cause a pulse generator to communicate a pulse into the at least one cable, sample a reflected waveform at an analog to digital converter, process raw data, and associate the raw data with a current GPS time and location.

28. The mobile infrastructure system of claim 26 wherein the controller comprises an Ethernet analyzer connected to the controller and being configured to plug into an existing switch, a radio frequency analyzer connected to the controller and being configured to test the antenna, and an environmental sensor connected to the controller.

29. The mobile infrastructure system of claim 26 wherein the mast antenna is configured to create the cellular wireless network with a plurality of mobile devices, further comprising a motor operably raising a telescoping mast of the mast antenna, the motor being connected to the controller and at least one of: the battery and the generator.

30. The mobile infrastructure system of claim 26 wherein the generator comprises at least one of: a liquid fuel-powered generator, a solar-powered generator, or a hydrogen-powered generator.

31. The mobile infrastructure system of claim 26 further comprising:
spools removably located on the trailer, the at least one cable wound around the spools when in a portable configuration; and
a robotic gripper, automatically actuated by the controller, gripping and moving at least one of the spools off of the trailer.

32. A method of operating mobile infrastructure system comprising:
retrieving a plurality of cable reels, each comprising the hybrid cable from a transportable platform with a robotic cable manager coupled to the transportable platform, the cable manager comprising a vision-guided reel handler;
coupling the transportable platform with a plurality of remote systems using the hybrid cable, the hybrid cable comprising an optical fiber and an electrical conductor;
communicating power from a fault-managed power generator of the transportable platform through the hybrid cable,
receiving data from a diagnostic controller;
forming a cellular wireless network with a plurality of mobile devices; and
controlling distribution of power through the hybrid cable.

33. The method of claim 32 further comprising coupling a mast to the transportable platform, forming the cellular wireless network with the plurality of mobile devices through the mast, and raising the mast comprises using a motor-driven telescoping mast.

34. The method of claim 32 further comprising triggering a pulse generator to communicate a pulse into the hybrid cable, sampling a reflected waveform at an analog to digital converter, processing raw data, and associating the raw data with a current GPS time and location.

35. The method of claim 32 further comprising:
communicating the raw data, the GPS time and location to the transportable platform through the optical fiber; and
obtaining diagnostic data from at least one of: an Ethernet analyzer to plug into an existing switch, a radio frequency analyzer to test an antenna, or an environmental sensor.

36. The method of claim 32 further comprising forming a private cellular wireless network with the plurality of mobile devices.

37. The method of claim 32 wherein retrieving the plurality of cable reels comprises retrieving the plurality of cable reels using a camera for aligning the reel handler, which comprises a robotic gripper, with a first reel of the plurality of reels.

38. The method of claim 32 wherein retrieving the plurality of cable reels with the reel handler comprises retrieving the plurality of cable reels using a cantilevered arm coupled to a gripper for moving the gripper outside of the platform upon which the cable reels, the power generator and the controller are mounted, the platform including wheels and being part of a portable trailer.

39. The method of claim 32 further comprising:
communicating data through at least one of: a cellular backhaul, a microwave backhaul, and a satellite backhaul; and
forming a second cellular wireless network, wherein the first wireless cellular network and the second wireless cellular network forming a mesh network.
